(19) United States
(12) Patent Application Publication
(10) Pub. No.: US 2013/0101027 A1
(43) Pub. Date: Apr. 25, 2013

(54) DEBLOCKING CONTROL BY INDIVIDUAL QUANTIZATION PARAMETERS

(71) Applicants: Matthias Narroschke, Schaafheim (DE); Thomas Wedi, Gross-Umstadt (DE); Semih Esenlik, Frankfurt (DE)

(72) Inventors: Matthias Narroschke, Schaafheim (DE); Thomas Wedi, Gross-Umstadt (DE); Semih Esenlik, Frankfurt (DE)

(21) Appl. No.: 13/806,872

(22) PCT Filed: Jun. 20, 2012
(86) PCT No.: PCT/EP12/02601

§ 371 Date: Dec. 26, 2012

Related U.S. Application Data
(60) Provisional application No. 61/498,832, filed on Jun. 20, 2011.

(51) Int. Cl. H04N 7/26

(52) U.S. Cl. CPC H04N 19/00909
USPC 375/240.03; 375/240.29

(57) ABSTRACT

The present invention relates to deblocking filtering, which may be advantageously applied for block-wise encoding and decoding of image or video signal. In particular, the present invention relates to automated decision on whether to apply or skip deblocking filtering for a block and to selection of the deblocking filter. The decision and/or selection is performed for predefined individual pixels based on the amount of quantization of the block the boundary of which is to be deblocked and on the amount of quantization of its neighboring block adjacent to the boundary, as well as on the position of the individual pixels.

### 1. FIELD OF THE INVENTION

The present invention relates to the filtering of images. In particular, the present invention relates to deblocking filtering and to decision whether to enable or disable deblocking filtering for an image region.

### 2. DESCRIPTION OF THE RELATED ART

At present, the majority of standardized video coding algorithms are based on hybrid video coding. Hybrid video coding methods typically combine several different lossless and lossy compression schemes in order to achieve the desired compression gain. Hybrid video coding is also the basis for ITU-T standards (H.26x standards such as H.261, H.263) as well as ISO/IEC standards (MPEG-X standards such as MPEG-1, MPEG-2, and MPEG-4). The most recent and advanced video coding standard is currently the standard denoted as H.264/MPEG-4 advanced video coding (AVC) which is a result of standardization efforts by joint video team (JVT), a joint team of ITU-T and ISO/IEC MPEG groups. This codec is being further developed by Joint Collaborative Team on Video Coding (JCT-VC) under a name High-Efficiency Video Coding (HEVC), aiming, in particular at improvements of efficiency regarding the high-resolution video coding.

A video signal input to an encoder is a sequence of images called frames, each frame being a two-dimensional matrix of pixels. All the above-mentioned standards based on hybrid video coding include subdividing each individual video frame into smaller blocks consisting of a plurality of pixels. The size of the blocks may vary, for instance, in accordance with the content of the image. The way of coding may be typically varied on a per block basis. The largest possible size for such a block, for instance in HEVC, is 64×64 pixels. It is then called the largest coding unit (LCU). In H.264/MPEG-4 AVC, a macroblock (usually denoting a block of 16×16 pixels) was the basic image element, for which the encoding is performed, with a possibility to further divide it in smaller subblocks to which some of the coding/decoding steps were applied.

Typically, the encoding steps of a hybrid video coding include a spatial and/or a temporal prediction. Accordingly, each block to be encoded is first predicted using either the blocks in its spatial neighborhood or blocks from its temporal neighborhood, i.e. from previously encoded video frames. A block of differences between the block to be encoded and its prediction, also called block of prediction residuals, is then calculated. Another encoding step is a transformation of a block of residuals from the spatial (pixel) domain into a frequency domain. The transformation aims at reducing the correlation of the input block. Further encoding step is quantization of the transform coefficients. In this step the actual lossy (irreversible) compression takes place. Usually, the compressed transform coefficient values are further compacted (losslessly compressed) by means of an entropy coding. In addition, side information necessary for reconstruction of the encoded video signal is encoded and provided together with the encoded video signal. This is for example information about the spatial and/or temporal prediction, amount of quantization, etc.

FIG. 1 is an example of a typical H.264/MPEG-4 AVC and/or HEVC video encoder 100. A subtractor 105 first determines differences e between a current block to be encoded of an input video image (input signal s) and a corresponding prediction block ŝ, which is used as a prediction of the current block to be encoded. The prediction signal may be obtained by a temporal or by a spatial prediction 180. The type of prediction can be varied on a per frame basis or on a per block basis. Blocks and/or frames predicted using temporal prediction are called “inter”-encoded and blocks and/or frames predicted using spatial prediction are called “intra”-encoded. Prediction signal using temporal prediction is derived from the previously encoded images, which are stored in a memory. The prediction signal using spatial prediction is derived from the values of boundary pixels in the neighboring blocks, which have been previously encoded, decoded, and stored in the memory. The difference e between the input signal and the prediction signal, denoted prediction error or residual, is transformed 110 resulting in coefficients, which are quantized 120. Entropy encoder 190 is then applied to the quantized coefficients in order to further reduce the amount of data to be stored and/or transmitted in a lossless way. This is mainly achieved by applying a code with code words of variable length wherein the length of a code word is chosen based on the probability of its occurrence.

Within the video encoder 100, a decoding unit is incorporated for obtaining a decoded (reconstructed) video signal s′. In compliance with the encoding steps, the decoding steps include dequantization and inverse transformation 130. The so obtained prediction error signal e′ differs from the original prediction error signal due to the quantization error, called also quantization noise. A reconstructed image signal s′ is then obtained by adding 140 the decoded prediction error signal e′ to the prediction signal §. In order to maintain the compatibility between the encoder side and the decoder side, the prediction signal ŝ is obtained based on the encoded and subsequently decoded video signal which is known at both sides the encoder and the decoder.

Due to the quantization, quantization noise is superposed to the reconstructed video signal. Due to the block-wise coding, the superposed noise often has blocking characteristics, which result, in particular for strong quantization, in visible block boundaries in the decoded image. Such blocking artifacts have a negative effect upon human visual perception. In order to reduce these artifacts, a deblocking filter 150 is applied to every reconstructed image block. The deblocking filter is applied to the reconstructed signal s′. For instance, the deblocking filter of H.264/MPEG-4 AVC has the capability of local adaptation. In the case of a high degree of blocking noise, a strong (narrow-band) low pass filter is applied, whereas for a low degree of blocking noise, a weaker (broad-band) low pass filter is applied. The strength of the low pass filter is determined by the prediction signal ŝ and by the quantized prediction error signal e′. Deblocking filter generally smoothes the block edges leading to an improved subjective quality of the decoded images. Moreover, since the filtered part of an image is used for the motion compensated prediction of further images, the filtering also reduces the prediction errors, and thus enables improvement of coding efficiency.

After a deblocking filter, a sample adaptive offset 155 and/or adaptive loop filter 160 may be applied to the image including the already deblocked signal s″. Whereas the deblocking filter improves the subjective quality, sample adaptive offset (SAO) and ALF aim at improving the pixel-wise fidelity (“objective” quality). In particular, SAO adds an offset in accordance with the immediate neighborhood of a pixel. The adaptive loop filter (ALF) is used to compensate image distortion caused by the compression. Typically, the adaptive loop filter is a Wiener filter with filter coefficients determined such that the mean square error (MSE) between the reconstructed s′ and source images s is minimized. The coefficients of ALF may be calculated and transmitted on a frame basis. ALF can be applied to the entire frame (image of the video sequence) or to local areas (blocks). An additional side information indicating which areas are to be filtered may be transmitted (block-based, frame-based or quadtree-based).

In order to be decoded, inter-encoded blocks require also storing the previously encoded and subsequently decoded portions of image(s) in the reference frame buffer 170. An inter-encoded block is predicted 180 by employing motion compensated prediction. First, a best-matching block is found for the current block within the previously encoded and decoded video frames by a motion estimator. The best-matching block then becomes a prediction signal and the relative displacement (motion) between the current block and its best match is then signalized as motion data in the form of three-dimensional motion vectors within the side information provided together with the encoded video data. The three dimensions consist of two spatial dimensions and one temporal dimension. In order to optimize the prediction accuracy, motion vectors may be determined with a spatial sub-pixel resolution e.g. half pixel or quarter pixel resolution. A motion vector with spatial sub-pixel resolution may point to a spatial position within an already decoded frame where no real pixel value is available, i.e. a sub-pixel position. Hence, spatial interpolation of such pixel values is needed in order to perform motion compensated prediction. This may be achieved by an interpolation filter (in FIG. 1 integrated within Prediction block 180).

For both, the intra- and the inter-encoding modes, the differences e between the current input signal and the prediction signal are transformed 110 and quantized 120, resulting in the quantized coefficients. Generally, an orthogonal transformation such as a two-dimensional discrete cosine transformation (DCT) or an integer version thereof is employed since it reduces the correlation of the natural video images efficiently. After the transformation, lower frequency components are usually more important for image quality then high frequency components so that more bits can be spent for coding the low frequency components than the high frequency components. In the entropy coder, the two-dimensional matrix of quantized coefficients is converted into a one-dimensional array. Typically, this conversion is performed by a so-called zig-zag scanning, which starts with the DC-coefficient in the upper left corner of the two-dimensional array and scans the two-dimensional array in a predetermined sequence ending with an AC coefficient in the lower right corner. As the energy is typically concentrated in the left upper part of the two-dimensional matrix of coefficients, corresponding to the lower frequencies, the zig-zag scanning results in an array where usually the last values are zero. This allows for efficient encoding using run-length codes as a part of/before the actual entropy coding.

The H.264/MPEG-4 H.264/MPEG-4 AVC as well as HEVC includes two functional layers, a Video Coding Layer (VCL) and a Network Abstraction Layer (NAL). The VCL provides the encoding functionality as briefly described above. The NAL encapsulates information elements into standardized units called NAL units according to their further application such as transmission over a channel or storing in storage. The information elements are, for instance, the encoded prediction error signal or other information necessary for the decoding of the video signal such as type of prediction, quantization parameter, motion vectors, etc. There are VCL NAL units containing the compressed video data and the related information, as well as non-VCL units encapsulating additional data such as parameter set relating to an entire video sequence, or a Supplemental Enhancement Information (SEI) providing additional information that can be used to improve the decoding performance.

FIG. 2 illustrates an example decoder 200 according to the H.264/MPEG-4 AVC or HEVC video coding standard. The encoded video signal (input signal to the decoder) first passes to entropy decoder 290, which decodes the quantized coefficients, the information elements necessary for decoding such as motion data, mode of prediction etc. The quantized coefficients are inversely scanned in order to obtain a two-dimensional matrix, which is then fed to inverse quantization and inverse transformation 230. After inverse quantization and inverse transformation 230, a decoded (quantized) prediction error signal e′ is obtained, which corresponds to the differences obtained by subtracting the prediction signal from the signal input to the encoder in the case no quantization noise is introduced and no error occurred.

The prediction signal is obtained from either a temporal or a spatial prediction 280. The decoded information elements usually further include the information necessary for the prediction such as prediction type in the case of intra-prediction and motion data in the case of motion compensated prediction. The quantized prediction error signal in the spatial domain is then added with an adder 240 to the prediction signal obtained either from the motion compensated prediction or intra-frame prediction 280. The reconstructed image s′ may be passed through a deblocking filter 250, sample adaptive offset processing 255, and an adaptive loop filter 260 and the resulting decoded signal is stored in the memory 270 to be applied for temporal or spatial prediction of the following blocks/images.

When compressing and decompressing an image, the blocking artifacts are typically the most annoying artifacts for the user. The deblocking filtering helps to improve the perceptual experience of the user by smoothing the edges between the blocks in the reconstructed image. One of the difficulties in deblocking filtering is to correctly decide between an edge caused by blocking due to the application of a quantizer and between edges which are part of the coded signal. Application of the deblocking filter is only desirable if the edge on the block boundary is due to compression artifacts. In other cases, by applying the deblocking filter, the reconstructed signal may be despaired, distorted. Another difficulty is the selection of an appropriate filter for deblocking filtering. Typically, the decision is made between several low pass filters with different frequency responses resulting in strong or weak low pass filtering. In order to decide whether deblocking filtering is to be applied and to select an appropriate filter, image data in the proximity of the boundary of two blocks are considered.

For instance, quantization parameters of the neighboring blocks may be considered. Alternatively or in addition, prediction modes such as intra or inter may be considered. Another possibility is to evaluated quantized prediction error coefficients, for instance, how many of them are quantized to zero. Reference frames used for the motion compensated prediction may also be indicative for selection of the filter, for instance, whether the same reference frames are used for prediction of the current block and the neighboring blocks. The decision may also be based on motion vectors used for the motion compensated prediction and on whether the motion vectors for the current block and for the neighboring blocks are the same or better they defer. The decision may involved spatial position of the samples such as distance to the block patch.

For instance, H.264/MPEG-4 AVC evaluates the absolute values of the first derivation (derivative) in each of the two neighboring blocks, the boundary of which is to be deblocked. In addition, absolute values of the first derivative across the edge between the two blocks are evaluated, as described, for instance in H.264/MPEG-4 AVC standard, Section 8.7.2.2. A similar approach is also described in US 2007/854204 A. The decision is taken for all pixels to be filtered based on the same criterion and the selection is performed for the entire block. HEVC employs a similar mechanism, however, uses also a second derivative.

However, with these approaches, erroneous decisions on whether an edge in the proximity of the boundary between two blocks is due to a blocking artifact or due to the contents of the image signal cannot be completely avoided. In particular, the decision as to whether to apply or not to apply deblocking filter and thus also selection of the filter are not precise enough, which may result in remaining annoying blocking artifacts and/or even in the distorting of the original image signal.

### SUMMARY OF THE INVENTION

Given these problems with the existing technology, it would be advantageous to provide an efficient deblocking filtering approach which could further reduce the number of wrong decisions on whether to apply or not to apply deblocking filter.

It is the particular approach of the present invention to perform the decision on whether to apply or skip the deblocking filtering and/or the selection of the appropriate filter for an individual pixel based on the quantization parameter of the adjacent blocks, the boundary of which is to be deblocked and based on the position of the individual pixel.

According to an aspect of the present invention, a method is provided for deblocking filtering of image blocks of pixels. The method comprises judging whether or not to apply a deblocking filter to pixels of a first and a second block adjacent to the boundary between the first and the second block and/or selection of the deblocking filter, and applying a deblocking filter when the judging is positive whereas not applying a deblocking filter when the judging is negative. Said judging and/or a selection of the deblocking filter is performed for an individual pixel of the block and based on the amount of quantization of the first block, amount of quantization of the second block, and on the position of said individual pixel.

According to another aspect of the present invention, a device is provided for deblocking filtering of image blocks of pixels. The device comprises a judging unit for judging whether or not to apply a deblocking filter to pixels of a first and a second block adjacent to the boundary between the first and the second block, and a filtering unit for applying the deblocking filter when the judging is positive and not applying the deblocking filter when the judging is negative. The judging unit is configured to judge and/or to select the deblocking filter for an individual pixel of the block based on the amount of quantization of the first block, amount of quantization of the second block, and on the position of said individual pixel.

### BRIEF DESCRIPTION OF THE DRAWINGS

The accompanying drawings are incorporated into and form a part of a specification to illustrate several embodiments of the present invention. These drawings together with the description serve to explain the principles of the invention. The drawings are only for the purpose of illustrating preferred and alternative examples of how the invention can be made and used and are not to be construed as limiting the invention to only the illustrated and described embodiments. Further features and advantages will become apparent from the following and more particular description of the various embodiments of the invention, as illustrated in the accompanying drawings, in which like reference numbers refer to like elements and wherein:

FIG. 1 is a block diagram illustrating an example of a video encoder;

FIG. 2 is a block diagram illustrating an example of a video decoder;

FIG. 3 is a schematic drawing illustrating application of a deblocking filter;

FIG. 4 is a schematic drawing illustrating a decision to apply or not to apply deblocking filter and a selection of a deblocking filter;

FIG. 5 is a schematic drawing illustrating parts of two neighboring blocks and pixels on their common boundary that may be involved in deblocking filtering;

FIG. 6 is a schematic drawing illustrating an example of pixels used for performing the judgment on whether to apply or not the deblocking filter;

FIG. 7 is a flow diagram illustrating deblocking filtering according to an embodiment of the present invention;

FIG. 8 is a flow diagram illustrating selection of a deblocking filter according to an embodiment of the present invention;

FIG. 9 is a flow diagram illustrating encoding using a deblocking filter according to an embodiment of the present invention;

FIG. 10 is a flow diagram illustrating decoding using a deblocking filter according to an embodiment of the present invention;

FIG. 11 is a block diagram showing a logical structure of a device for filtering according to an embodiment of the invention;

FIG. 12 shows an overall configuration of a content providing system for implementing content distribution services;

FIG. 13 shows an overall configuration of a digital broadcasting system;

FIG. 14 shows a block diagram illustrating an example of a configuration of a television;

FIG. 15 shows a block diagram illustrating an example of a configuration of an information reproducing/recording unit that reads and writes information from and on a recording medium that is an optical disk;

FIG. 16 shows an example of a configuration of a recording medium that is an optical disk;

FIG. 17A shows an example of a cellular phone;

FIG. 17B is a block diagram showing an example of a configuration of a cellular phone;

FIG. 18 illustrates a structure of multiplexed data;

FIG. 19 schematically shows how each stream is multiplexed in multiplexed data;

FIG. 20 shows how a video stream is stored in a stream of PES packets in more detail;

FIG. 21 shows a structure of TS packets and source packets in the multiplexed data;

FIG. 22 shows a data structure of a PMT;

FIG. 23 shows an internal structure of multiplexed data information;

FIG. 24 shows an internal structure of stream attribute information;

FIG. 25 shows steps for identifying video data;

FIG. 26 shows an example of a configuration of an integrated circuit for implementing the moving picture coding method and the moving picture decoding method according to each of embodiments;

FIG. 27 shows a configuration for switching between driving frequencies;

FIG. 28 shows steps for identifying video data and switching between driving frequencies;

FIG. 29 shows an example of a look-up table in which video data standards are associated with driving frequencies;

FIG. 30A is a diagram showing an example of a configuration for sharing a module of a signal processing unit; and

FIG. 30B is a diagram showing another example of a configuration for sharing a module of the signal processing unit.

### DETAILED DESCRIPTION OF THE INVENTION

The problem underlying the present invention is based on the observation that the prior art techniques still result in numerous wrong decisions on whether or not to apply deblocking filtering in the proximity of the boundary between two blocks in image. In order to improve the reliability of the decision and the quality of filtering in accordance with the present invention, improved decision criterions/rules are provided.

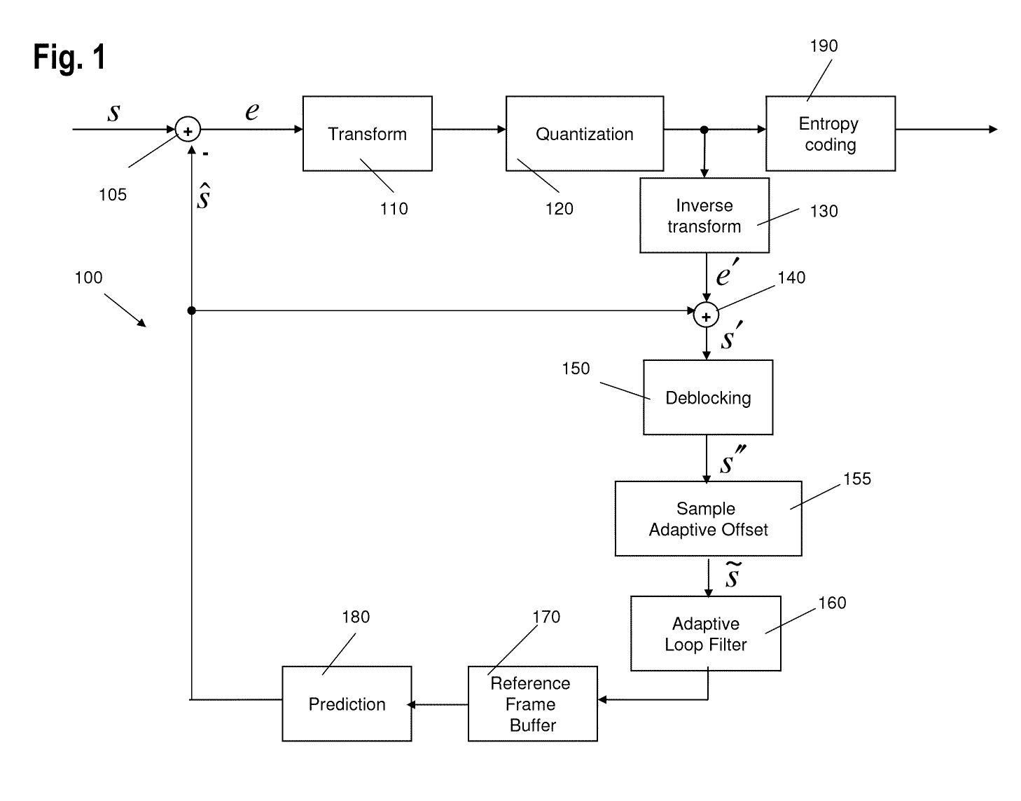

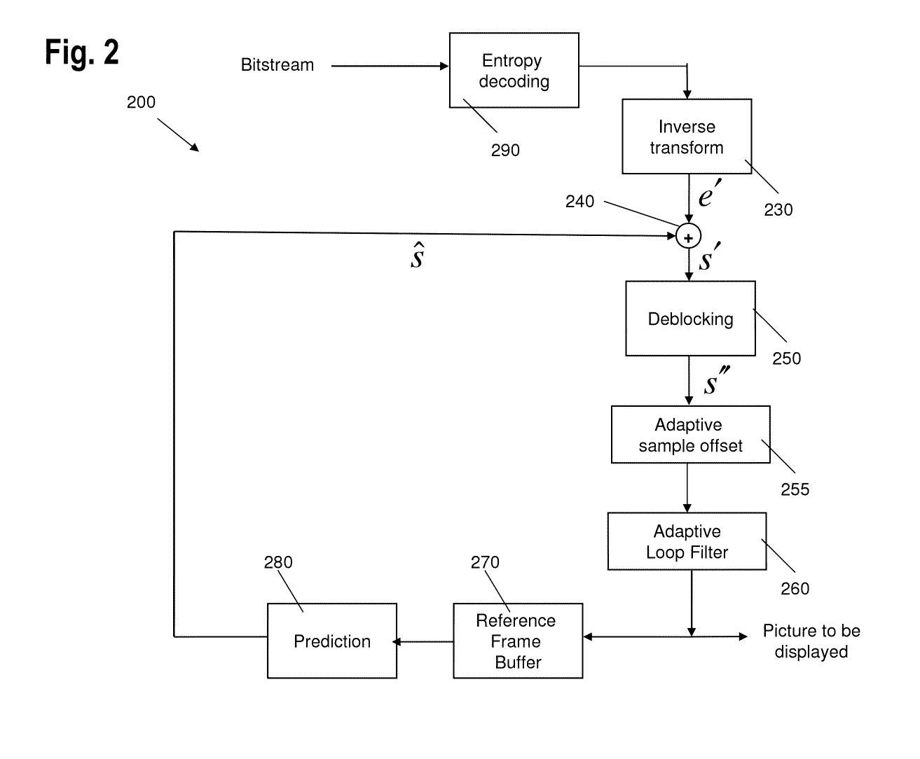

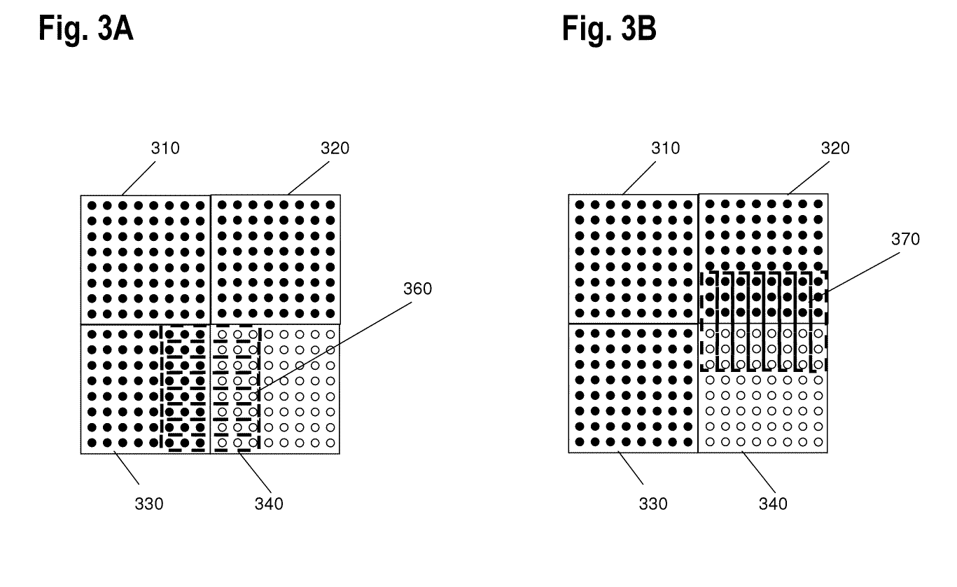

FIG. 3 shows an example of an application of a deblocking filter such as 150 and 250 referred to in the description of FIGS. 1 and 2, respectively. Such a deblocking filter may decide for each sample at a block boundary whether it is to be filtered or not. When it is to be filtered, a low pass filter is applied. The aim of this decision is to filter only those samples, for which the large signal change at the block boundary results from the quantization applied in the block-wise processing as described in the background art section above. The result of this filtering is a smoothed signal at the block boundary. The smoothed signal is less annoying to the viewer than the blocking artifact. Those samples, for which the large signal change at the block boundary belongs to the original signal to be coded, should not be filtered in order to keep high frequencies and thus the visual sharpness. In the case of wrong decisions, the image is either unnecessarily smoothened or remains blocky.

FIG. 3A illustrates decision on a vertical boundary (to filter or not to filter with a horizontal deblocking filter) and FIG. 3B illustrates decision on a horizontal boundary (to filter or not with a vertical deblocking filter). In particular, FIG. 3A shows a current block 340 to be decoded and its already decoded neighbouring blocks 310, 320, and 330. For the pixels 360 in a line, the decision is performed. Similarly, FIG. 3B shows the same current block 340 and decision performed for the pixels 370 in a column.

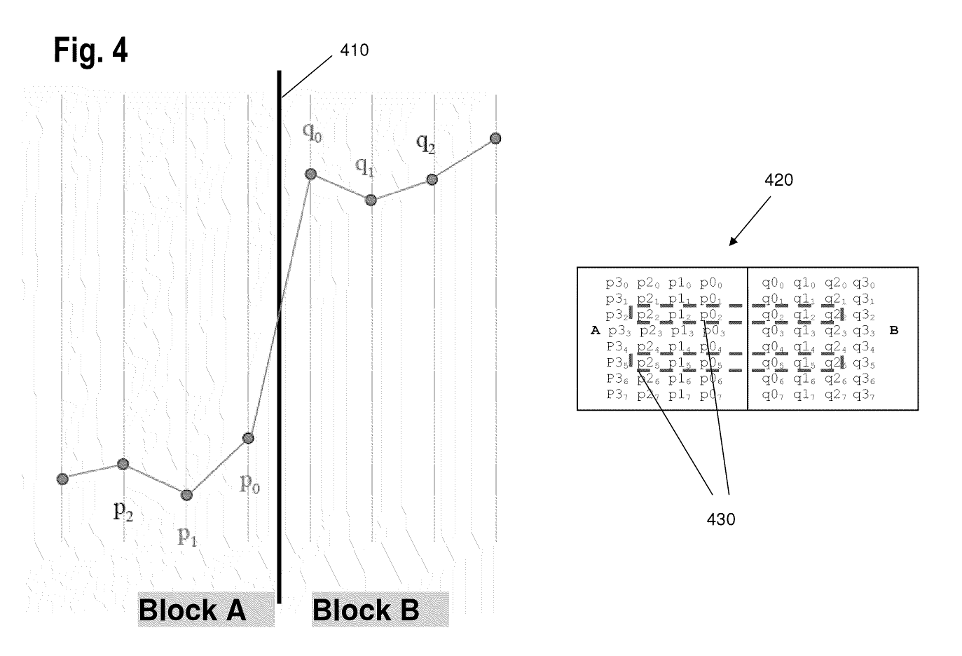

The judgment on whether to apply the deblocking filter may be performed as follows, similarly to H.264/MPEG-4 AVC. Let us take a line of six pixels 360, the first three pixels p2, p1, p0 of which belong to a left neighboring block A 330 and the following three pixels q0, q1, and q2 of which belong to the current block B 340 as also illustrated in FIG. 4. Line 410 illustrates a boundary between the blocks A and B. Pixels p0 and q0 are the pixels of the left neighbor A and of the current block B, respectively, located directly adjacent to each other. Pixels p0 and q0 are filtered by the deblocking filtered for instance, when the following conditions are fulfilled:

|p₀−q₀|<α_{H264}(QP_{New}),

|p₁−p_{O}|<β_{H264}(QP_{New}), and

|q₁−q₀|<β_{H264}(QP_{New}),

wherein, in general, β_{H264}(QP_{New})<α_{H264}(QP_{New}). These conditions aim at detecting whether the difference between p0 and q0 stems from blocking artifacts. They correspond to evaluation of the first derivation within each of the blocks A and B and between them.

Pixel p1 is filtered if, in addition to the above three conditions, also the following condition is fulfilled:

|p₂−p₀<β_{H264}(QP_{New}).

Pixel q1 is filtered, for instance, if in addition to the above first three conditions also the following condition is fulfilled:

|q₂−q₀|<=_{H264}(QP_{New}).

These conditions correspond to a first derivation within the first block and a first derivation within the second block, respectively. In the above conditions, OP denotes quantization parameter indicating the amount of quantization applied, and β,α are scalar constants. In particular, QP_{New} is quantization parameter derived based on quantization parameters QP_{A} and QP_{B} applied to the respective first and second block A and B as follows:

QP_{New}=(QP_{A}+QP_{B}+1)>>1,

wherein “>>” denoted right shift by one bit.

The above conditions correspond to evaluating of the first derivative within the blocks. The decision may be performed only for selected line or lines of a block, while the filtering of pixels accordingly is then performed for all lines 360. An example 420 of lines 430 involved in decision in compliance with HEVC is illustrated in FIG. 4. Based on lines 430, the decision whether to filter entire block is carried out.

Another example of deblocking filtering in HEVC can be found in JCTVC-E603 document, Section 8.6.1, of JTC-VC, of ITU-T SG16 WP3 and ISO/IEC JTC1/SC29/WG11, freely available under http://wftp3.itu.int/av-arch/jctvc-site/.

Accordingly, in HEVC the two lines 430 are used to decide whether and how the deblocking filtering is to be applied. The example 420 assumes the evaluating of the third (with index 2) and the sixth (with index 5) line for the purpose of horizontally blocking filtering. In particular, the second derivative within each of the blocks is evaluated resulting in the obtaining of measures d2 and d5 as follows:

d₂=|p2₂−2·p1₂+p0₂|+|q2₂−2·q1₂+q0₂|,

d₅=|p2₅−2·p1₅+p0₅|+|q2₅−2·q1₅+q0₅|.

The pixels p belong to block A and pixels q belong to block B. The first number after p or q denotes column index and the following number in subscript denotes row number within the block. The deblocking for all eight lines illustrated in the example 420 is enabled when the following condition is fulfilled:

d=d₂+d₅<β(QP_{Frame}).

If the above condition is not fulfilled, no deblocking is applied. In the case that deblocking is enabled, the filter to be used for deblocking is determined. This determination is based on the evaluation of the first derivative between the blocks A and B. In particular, for each line i, wherein i is an integer between 0 and 7, it is decided whether a strong or a weak low pass filter is to be applied. A strong filter is elected if the following condition is fulfilled.

|p3ᵢ−p0ᵢ|+|q3ᵢ−q0ᵢ|<(β(QP_{Frame})>>3)

[symbol]

d<(β(QP_{Frame})>>2)

[symbol]

|p0ᵢ−q0ᵢ|<((t_{c}(QP_{Frame})·5+1)>>1).

In compliance with the HEVC model “the strong filter” filters samples p2ᵢ, p1ᵢ, p0ᵢ, q0ᵢ, q1ᵢ, q2ᵢ using p3ᵢ, p2ᵢ, p1ᵢ, p0ᵢ, q0ᵢ, q1ᵢ, q2ᵢ, q3ᵢ, whereas a “weak filter” filters samples p1ᵢ, p0ᵢ, q0ᵢ, q1ᵢ using p2ᵢ, p1ᵢ, p0ᵢ, q0ᵢ, q1ᵢ, q2ᵢ. In the above conditions, parameters β and t_{c} are both functions of the quantization parameter QP_{Frame} which may be set for a slice of the image or the like. The values of β and t_{c} are typically derived based on QP_{Frame} using lookup tables.

Moreover, in accordance with JCTVC-276, a JCTVC contribution by A. Norkin, K. Andersson, R. Sjöberg, CE12.1: Ericsson deblocking filter, Geneva, CH, March, 2011, when

|(9·(q0ᵢ−p0ᵢ)−3·(q1ᵢ−p1ᵢ)+8)>>4|<10·t_{c}(QP_{Frame})

the sample p0ᵢ, q0ᵢ closest to the boundary are filtered without further condition. Sample p0ᵢ is filtered when further

dₚ<β(QP_{Frame})/6

and sample q1ᵢ is filtered when further

d_{q}<β(QP_{Frame})/6.

In accordance with the present invention for each sample to be deblocked, individual decision and/or selection of the deblocking filter is performed. The decision and/or selection of the deblocking filter is based on the individual quantization parameter values QP_{A} and QP_{B} applied to the samples of the respective blocks A and B, as well as on the position of the sample. This may be achieved by providing individual threshold values for each sample derived based on the two quantization parameter values as well as from the position of the sample. The position of a sample may be defined by the distance of the sample with respect to the boundary, which is to be deblocked, i.e. by the boundary between the current block and an adjacent block.

In accordance with an embodiment of the present invention, the following thresholds may be defined for comparing a first order gradient or a second order gradient (derivative):

βₚ₀(QP_{A},QP_{B}) β_{q0}(QP_{A},QP_{B})

βₚ₁(QP_{A},QP_{B}) β_{q1}(QP_{A},QP_{B})

βₚ₂(QP_{A},QP_{B}) β_{q2}(QP_{A},QP_{B})

βₚ₃(QP_{A},QP_{B}) β_{q3}(QP_{A},QP_{B})

This means that for horizontal deblocking filtering, a separate threshold is defined for pixels in the same line in each individual column depending on the quantization parameter of the current block and the adjacent block, the boundary to which is to be deblocked. This also means that for vertical deblocking filtering, a separate threshold is defined for pixels in the same column in each individual line depending on the quantization parameter of the current block and the adjacent block, the boundary to which is to be deblocked. Alternatively or in addition, the threshold t_{c} may also be determined individually, which means that the following thresholds may be defined separately and independently:

t_{c,p0}(QP_{A},QP_{B}) t_{c,q0}(QP_{A},QP_{B})

t_{c,p1}(QP_{A},QP_{B}) t_{c,q1}(QP_{A},QP_{B})

t_{c,p2}(QP_{A},QP_{B}) t_{c,q2}(QP_{A},QP_{B})

t_{c,p3}(QP_{A},QP_{B}) t_{c,q3}(QP_{A},QP_{B})

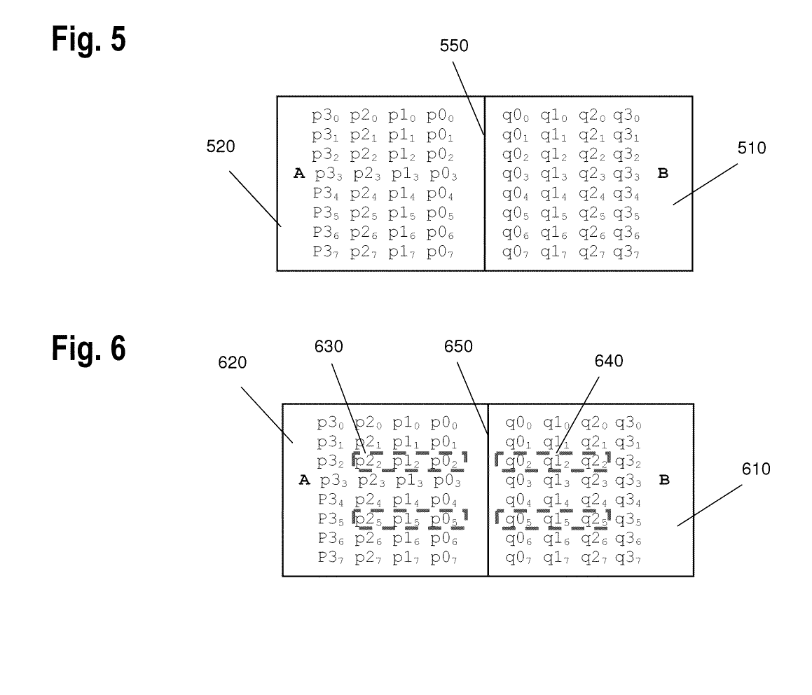

FIG. 5 illustrates two neighboring blocks A and B, wherein block B 510 is the current block and block A 520 is a previously decoded block adjacent to the current block 510. It is noted that the blocks A and B are not completely shown in FIG. 5. Rather, the boundary-nearest columns of blocks A and B relevant for decisions and filtering by the blocking filter are illustrated. Line 550 illustrates the boundary between these two blocks. Pixels of the current block B 510 are denoted as “q” and the pixels of the adjacent block A 520 are denoted as “p”. The numeral following “p” or “q” denotes index the column of pixels starting from zero at the boundary between the blocks and increasing with the increasing distance from the boundary. The second index following the column index and written as a subscript denotes the row index of the respective blocks A and B.

An example of determining the individual thresholds depending on the position of samples to be filtered is shown below:

βₚ₀(QP_{A},QP_{B})=β((QP_{A}+QP_{B}+1)>>1)

β_{q0}(QP_{A},QP_{B})=β((QP_{A}+QP_{B}+1)>>1)

βₚ₁(QP_{A},QP_{B})=β((3·QP_{A}+QP_{B}+2)>>2)

β_{q1}(QP_{A},QP_{B})=β((QP_{A}+3·QP_{B}+2)>>2)

βₚ₂(QP_{A},QP_{B})=β(QP_{A})

β_{q2}(QP_{A},QP_{B})=β(QP_{B})

The symbol “>>” denotes the bit-wise shift right by the number of bits following the symbol. The function data may be implemented as a one-dimensional look-up table similarly to the HEVC software model HM3.0.

Similarly, the threshold t_{c} may be derived as follows:

t_{c,p0}(QP_{A},QP_{B})=t_{c}((QP_{A}+QP_{B}+1)>>1)

t_{c,q0}(QP_{A},QP_{B})=t_{c}((QP_{A}+QP_{B}+1)>>1)

t_{c,p1}(QP_{A},QP_{B})=t_{c}((3·QP_{A}+QP_{B}+2)>>2)

t_{c,q1}(QP_{A},QP_{B})=t_{c}((QP_{A}+3·QP_{B}+2)>>2)

t_{c,p2}(QP_{A},QP_{B})=t_{c}(QP_{A})

t_{c,q2}(QP_{A},QP_{B})=t_{c}(QP_{B})

The function t_{c} may be defined for each position individually by a one-dimensional look-up table, i.e. look-up table with values depending only on one input value such as (1+QP_{A}+QP_{B})>>1 and/or QP_{A} or QP_{B}.

FIG. 6 illustrates the decision whether to deblock or skip the deblocking of pixels close to the boundary in both blocks, the current block B 610 and the adjacent block A 620. For the decision regarding 8 lines (in this case rows) of pixels, only two lines, namely the third line with index 2 and the sixth line with index 5, are considered. In particular, measures d_{P} and d_{Q} representing a second order gradient within the respective blocks A and B are calculated as follows:

dₚ=p2₂−2·p1₂+p0₂|+|p2₅−2·p1₅+p0₅|

d_{q}=|q2₂−2·q1₂+q0₂|+|q2₅−2·q1₅+q0₅|

Accordingly, it is decided to apply the deblocking filtering for all 8 rows of blocks A and B when the following condition is fulfilled:

d=d_{q}+dₚ<β_{enable}(QP_{A},QP_{B},pos)

In the case when the above condition is fulfilled, the deblocking filtering is enabled and it is decided whether a stronger or a weaker low pass filter is to be applied. In particular, a strong low pass filter is selected if the following condition applies:

|p3ᵢ−p0ᵢ|+|q3ᵢ−q0ᵢ|<(β_{select}(QP_{A},QP_{B},pos)>>3)

[symbol]

d<(β_{select}(QP_{A},QP_{B},pos)>>2)

[symbol]

|p0ᵢ−q0ᵢ|<((t_{c,select}(QP_{A},QP_{B},pos)·5+1)>>1)

The strong filter filters samples p2ᵢ, p1ᵢ, p0ᵢ, q0ᵢ, q1ᵢ, q2ᵢ using the samples p3ᵢ, p2ᵢ, p1ᵢ, p0ᵢ, q0ᵢ, q1ᵢ, q2ᵢ, q3ᵢ.

The weak filter filters samples p1ᵢ, p0ᵢ, q0ᵢ, q1ᵢ using the samples p2ᵢ, p1ᵢ, p0ᵢ, q0ᵢ, q1ᵢ, q2ᵢ. When

|(9·(q0ᵢ−p0ᵢ)−3·(q1ᵢ−p1ᵢ)+8)>>4|<10·t_{c,enable}(QP_{A},QP_{B},pos)

the samples p0ᵢ, q0ᵢ are filtered without further condition. Sample p1ᵢ is filtered when

dₚ<β_{enable}_{_{—}}_{weak}(QP_{A},QP_{B},pos)/6

and sample q1ᵢ is filtered when

d_{q}<β_{enable}_{_{—}}_{weak}(QP_{A},QP_{B},pos)/6

Here, using samples for filtering means applying a tap of the filter to these samples, not only to modify the samples by the filter. As can be seen from the above example, the strong filter modifies the filtered samples by applying taps to samples used for filtering.

Advantageously, the threshold for enabling of the deblocking filtering, depending on parameters QP_{A}, QP_{B}, pos may be implemented as a full three-dimensional look-up table with individual entries for possible combinations of the three parameters. In particular, for all combinations of QP_{A}, QP_{B}, pos the threshold β_{enable}(QP_{A}, QP_{B}, pos) may be defined. Alternatively, only selected combinations may be included in the look-up table and missing combinations may be obtained by a predetermined interpolation.

However, the present invention is not limited thereto and the threshold function may be defined as a rule or a formula and the particular value may be generated instantly, based on the three parameters QP_{A}, QP_{B}, pos.

Still alternatively, a full three-dimensional look-up table with individual entries for possible combinations of the position, the average and the distance between quantization parameters of the neighboring blocks, the boundary of which is to be deblocked, may be stored. In particular, the look-up table may include combinations of the sample position and of the average, for instance (QP_{A}+QP_{B}+1)>>1, and a difference QP_{A}−QP_{B} or an absolute difference |QP_{A}−QP_{B}|.

The look-up table for β_{enable}(QP_{A}, QP_{B}, pos)—the threshold for enabling/disabling of the deblocking filtering—may be defined for instance, as full three-dimensional look-up table having individual entries for possible combinations of QP_{A}, QP_{B} as well as for each possible sample position p3, p2, p1, p0, q0, q1, q2, q3. For example, the threshold for different samples may be defined as follows, depending on the position of the sample, in particular, on its distance from the boundary:

For sample p0:β_{enable}(QP_{A},QP_{B})=β((QP_{A}+QP_{B}+1)>>1)

For sample p1:β_{enable}(QP_{A},QP_{B})=β((3·QP_{A}+QP_{B}+2)>>2)

For sample:p2:β_{enable}(QP_{A},QP_{B})=β(QP_{A})

For sample:q0:β_{enable}(QP_{A},QP_{B})=β((QP_{A}+QP_{B}+1)>>1)

For sample:q1:β_{enable}(QP_{A},QP_{B})=β((QP_{A}+3·QP_{B}+2)>>2)

For sample:q2:β_{enable}(QP_{A},QP_{B})=β(QP_{B})

Similarly, the threshold β_{select}(QP_{A}, QP_{B}, pos) employed for selecting of a filter maybe defined as a full three-dimensional look-up table having individual entries for possible combinations of QP_{A}, QP_{B} as well as for each possible sample position p3, p2, p1, p0, q0, q1, q2, q3. For instance, this threshold β may be determined depending on the distance of the sample from the boundary:

For sample p0:β_{select}(QP_{A},QP_{B})=β((QP_{A}+QP_{B}+1)>>1)

For sample p1:β_{select}(QP_{A},QP_{B})=β((3·QP_{A}+QP_{B}+2)>>2)

For sample p2:β_{select}(QP_{A},QP_{B})=β(QP_{A})

For sample q0:β_{select}(QP_{A},QP_{B})=β((QP_{A}+QP_{B}+1)>>1)

For sample q1:β_{select}(QP_{A},QP_{B})=β((QP_{A}+3·QP_{B}+2)>>2)

For sample q2:β_{select}(QP_{A},QP_{B})=β(QP_{B})

Similarly, the thresholds t_{c,enable}(QP_{A}, QP_{B}, pos) and t_{c,select}(QP_{A}, QP_{B}, pos) may also be specified to depend for each individual sample on its distance from the boundary and on the quantization parameter of the two blocks A and B. In particular, the threshold for enabling the blocking filtering may be defined as a full three-dimensional look-up table having individual entries for possible combinations of QP_{A}, QP_{B} as well as for each possible sample p3, p2, p1, p0, q0, q1, q2, q3. For example, the threshold t_{c,enable} may be defined as follows:

For sample p0:t_{c,enable}(QP_{A},QP_{B})=t_{c}((QP_{A}+QP_{B}+1)>>1)

For sample p1:t_{c,enable}(QP_{A},QP_{B})=t_{c}((3·QP_{A}+QP_{B}+2)>>2)

For sample p2:t_{c,enable}(QP_{A},QP_{B})=t_{c}(QP_{A})

For sample q0:t_{c,enable}(QP_{A},QP_{B})=t_{c}((QP_{A}+QP_{B}+1)>>1)

For sample q1:t_{c,enable}(QP_{A},QP_{B})=t_{c}((QP_{A}+3·QP_{B}+2)>>2)

For sample q2:t_{c,enable}(QP_{A},QP_{B})=t_{c}(QP_{B})

The threshold for selecting a strong filter may be defined as full three-dimensional look-up table having individual entries for possible combinations of QP_{A}, QP_{B} as well as for each possible sample p3, p2, p1, p0, q0, q1, q2, q3. For instance, the threshold t_{c} select may be defined as follows:

For sample p0:t_{c,select}(QP_{A},QP_{B})=t_{c}((QP_{A}+QP_{B}+1)>>1)

For sample p1:t_{c,select}(QP_{A},QP_{B})=t_{c}((3·QP_{A}+QP_{B}+2)>>2)

For sample p2:t_{c,select}(QP_{A},QP_{B})=t_{c}(QP_{A})

For sample q0:t_{c,select}(QP_{A},QP_{B})=t_{c}((QP_{A}+QP_{B}+1)>>1)

For sample q1:t_{c,select}(QP_{A},QP_{B})=t_{c}((QP_{A}+3·QP_{B}+2)>>2)

For sample q2:t_{c,select}(QP_{A},QP_{B})=t_{c}(QP_{B})

Finally, the threshold β_{enable}_{_{—}}_{weak}(QP_{A}, QP_{B}, pos) for enabling a weak low-pass filter may be defined as a full three-dimensional look-up table having individual entries for possible combinations of QP_{A}, QP_{B} as well as for each possible sample p3, p2, p1, p0, q0, q1, q2, q3. For instance, the threshold for enabling a weak low-pass filter may be defined as follows:

For sample p0:β_{enable}_{_{—}}_{weak}(QP_{A},QP_{B})=β((QP_{A}+QP_{B}+1)>>1)

For sample p1:β_{enable}_{_{—}}_{weak}(QP_{A},QP_{B})=β((3+QP_{A}+QP_{B}+2)>>2)

For sample p2:β_{enable}_{_{—}}_{weak}(QP_{A},QP_{B})=β(QP_{A})

For sample q0:β_{enable}_{_{—}}_{weak}(QP_{A},QP_{B})=β((QP_{A}+QP_{B}+1)>>1)

For sample q1:β_{enable}_{_{—}}_{weak}(QP_{A},QP_{B})=β((QP_{A}+3·QP_{B}+2)>>2)

For sample q2:β_{enable}_{_{—}}_{weak}(QP_{A},QP_{B})=β(QP_{B})

It is noted that the above equations for determining the threshold, included in the conditions evaluated for deciding on whether to apply or skip the deblocking filtering and to decide about the type of the filter to be applied, are only examples. These examples show the approach of the present invention, namely individual selection and decision on filtering an/or selection of the filter depending on quantization parameters of the involved blocks A and B and the position of individual samples, in particular, their distance from the boundary between the blocks A and B.

The blocking artefacts are annoying for a user, especially, in a case when one of the blocks is quantized very coarsely and one of the blocks is quantized with a very fine granularity. The larger the quantization parameter (QP) value, the coarser the quantization. Thus, it may be advantageous to select a threshold for decision and/or selection operations to be a function of the larger of the two quantization parameter values QP_{A} and QP_{B}. Accordingly, especially for the deblocking of the samples in the proximity to the edge such as p0 and q0, it could be beneficial to select thresholds based on the maximum of the two quantization parameter values as follows:

For sample p0:β_{select}(QP_{A},QP_{B})=β(max(QP_{A},QP_{B}))

For sample q0:β_{select}(QP_{A},QP_{B})=β(max(QP_{A},QP_{B}))

The above examples illustrate various ways, in which the present invention may be implemented. In particular, in accordance with the present invention, a method is provided which comprises deciding whether or not to enable deblocking filtering applied to pixels in the proximity of a boundary between two blocks and, in case it is decided to enable the filtering, applying a deblocking filter, and not applying the deblocking filter otherwise. The decision whether to apply the deblocking filter or not is performed for an individual pixel of a block and is based on the amount of quantization (quantization parameter) of the two blocks to which the pixels close to the boundary belong. Furthermore, the decision is performed based on the position of said individual pixel for which the decision is performed. Alternatively, or in addition, the selection of the filter for the individual pixel with which the pixel is to be filtered is performed based on the two quantization parameters of the blocks and on the position of the pixel.

In particular, the decision may include determining for the individual pixel of a first threshold based on the amount of quantization of the first block and the second block sharing a boundary which is to be filtered and on the position of said individual pixel. The judging (decision) on whether to apply or not the filtering may include the step of comparing certain measure based on features of the first and/or the second block with the first threshold. For instance, the measure may be a difference, an absolute difference or a second order difference between the pixels of the first block or between the pixels of the second block. Alternatively, or in addition, the measure can be an average of the pixels or difference or average considering pixels of both blocks. However, the present invention is not limited thereby and the measure may be derived from the sample values (pixels) or other features of the first and the second box such as type of the coding. The features of the first and/or the second block may include the quantization parameter, prediction type, usage of reference frame, motion vectors, etc.

Similarly, the selection of a filter to be applied in the case, when it is decided that a filter is to be applied, may include determining for the individual pixel a second threshold based on the amount of quantization of the first block, amount of quantization of the second block and on the position of said individual pixel. The selection is then performed by comparing a predefined measure based on the features of the first and/or the second block with the second threshold. The second and the first threshold may be calculated in the same way or differently.

Advantageously, the decision and/or the selection of the deblocking filter is performed individually for each of a predefined plurality of pixels close to the boundary between the first and the second block, wherein the pixels belong to respective first and the second block. The position of the individual pixel here may refer to the distance of the individual pixel from the boundary between the first and the second block and may include the fact whether the individual pixel belongs to the first block or to the second block.

There may be a plurality of thresholds involved in the decision and selection process. For instance, the threshold may be defined for enabling or disabling filtering of individual pixels. However, the enabling and disabling of the deblocking filtering may also be decided only based on predefined representative pixels of the block, while the selection and the filtering may then be performed for all predefined pixels in the block, individually. Another threshold involved may be for selecting between a plurality of predefined deblocking filters, for instance at least a strong and a weak low pass filter (a filter with a narrow band or a broad band characteristics) may be selectable. The threshold for a selection between strong or weak low pass filtering may thus be defined. In addition, further conditions and thresholds may specify which of the predefined pixels are to be filtered.

In the threshold for decision and/or selection of the deblocking filter may be given by a look-up table stored in a memory including threshold values for combinations of the amount of quantization of the first block, amount of quantization of the second block, and on the position of said individual pixel. Alternatively, the threshold values may be given as a combinations of an average and/or difference of amount of quantization of the first block and the second block and on the position of said individual pixel. However, the present invention is not limited by the implementation of the threshold function as a look-up table. The threshold may be given by a formula involving for the individual pixel a weighted average of the amount of quantization of the first block and the amount of quantization of the second block with weights depending on the position of said individual pixel. The judging and/or the selection of the deblocking filter for an individual pixel located directly adjacent to the boundary between the first and the second block may further be based on the maximum of the amount of quantization of the first block and the amount of quantization of the second block.

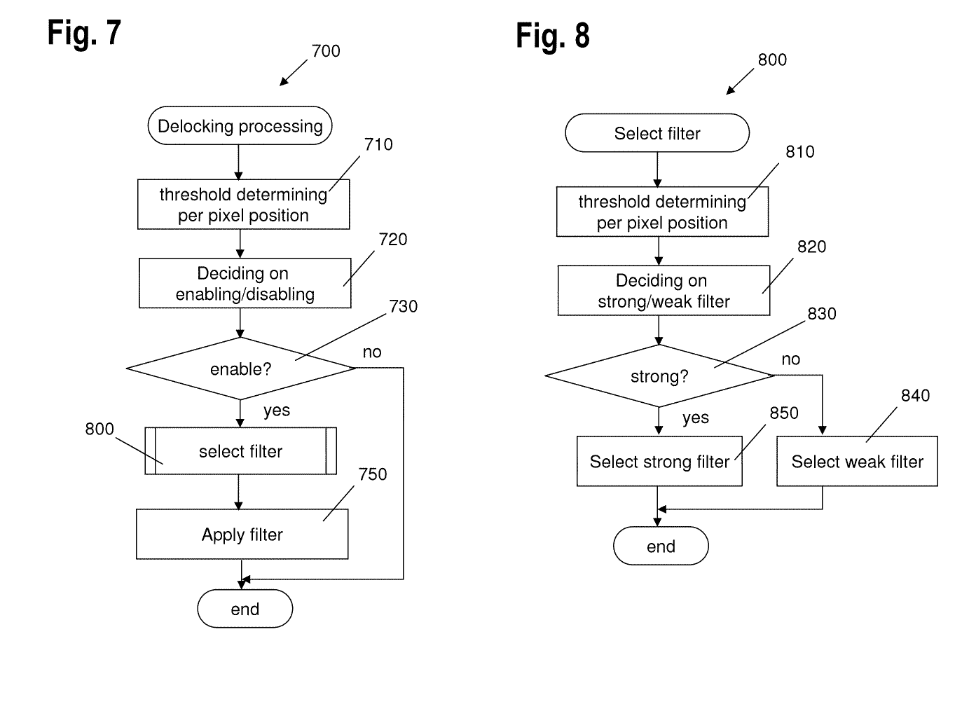

An example of a method according to the present invention is illustrated in FIG. 7. The method 700 includes the step of threshold determining 710 performed based on a pixel position. Based on the determined threshold, decision 720 for enabling or disabling the filtering is performed. When it is decided to enable filtering 730, the filter is selected 800 and applied 750 accordingly. The filter selection and/or application may also be performed individually per pixels. When the filtering is disabled (“no” in step 730) no filtering is applied to the pixel or to a plurality of pixels.

FIG. 8 illustrates a method for selecting the deblocking filter 800 performed in the case when it is decided to apply the deblocking filter. In this example, a threshold 810 is determined per pixel position and it is decided whether a strong or a weak filter is to be applied 820. If it is decided 830 that a strong low pass filter is to be applied, a strong low pass filter is selected 850. If it is decided that a weak filter is to be applied, a weak low pass filter 840 is selected. The selection of strong or a weak filter may include taking a signal predefined filter or a selection between a plurality of predefined filters. The selection itself may be based on evaluating of conditions based on further thresholds, which may also depend on the quantization parameters of the first and/or the second block or on the position of the individual pixel for which the filter is to be selected.

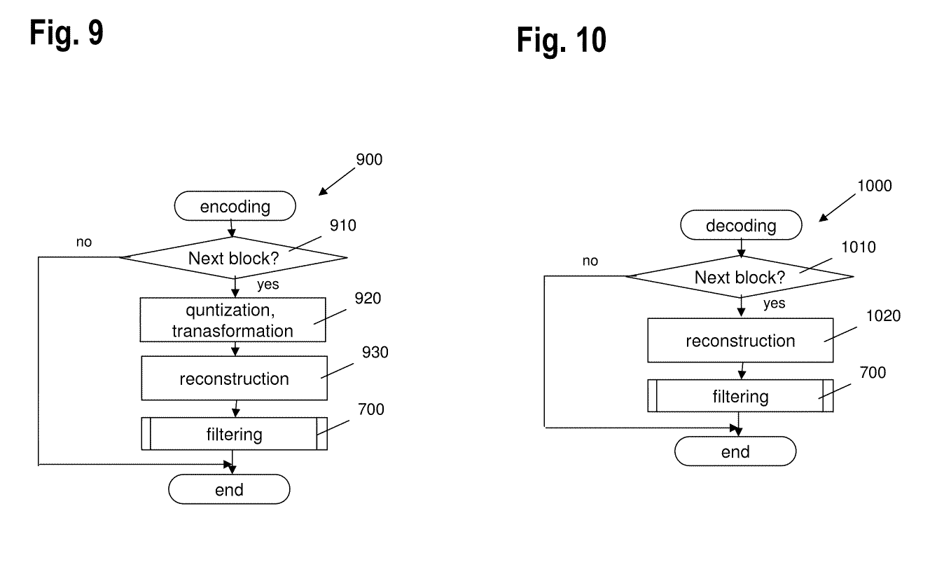

FIGS. 9 and 10 show examples of encoding 900 and decoding 1000 employing deblocking filtering 700 described above. The filtering 700 may then be efficiently employed during encoding and/or decoding of an image or video. This is illustrated in the flow diagram 900 in flow diagram 1000 for encoding and decoding, respectively.

The encoding 1491 is performed for each block 910 and includes coding the block comprising, for instance, quantization and transformation 920 and the following reconstruction 930 of the compressed signal. The reconstructed image signal is then filtered 700 as explained above.

Decoding 1000 is performed analogically. For each block 1010, the image data is decoded and reconstructed 1020 and the reconstructed image blocks are filtered 700, as described above. The encoding and decoding may be performed in accordance with the encoding and decoding described with reference to FIG. 1 and FIG. 2 respectively.

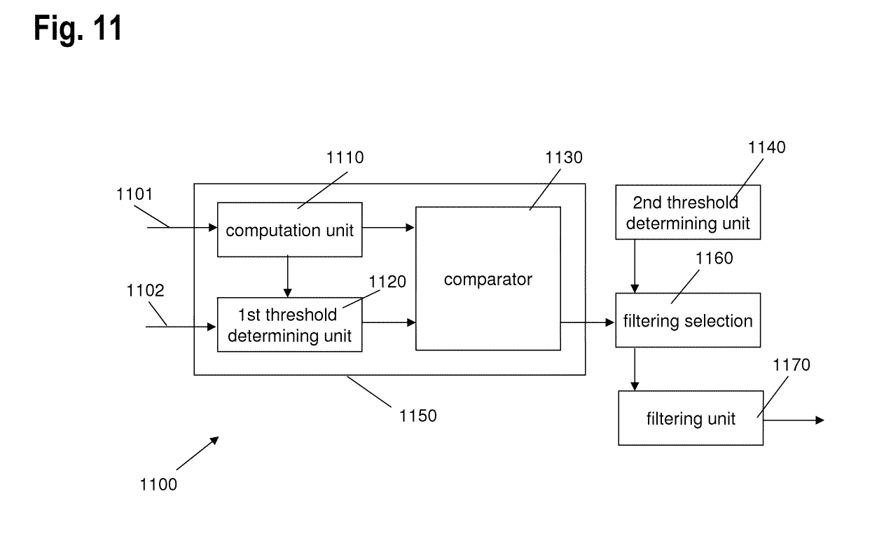

FIG. 11 illustrates judging unit 1150 for judging whether or not to apply deblocking filtering. It may include a computation unit 1110 for calculating condition and the first threshold determining unit 1120 for calculating a threshold based on features of the image such as quantization parameter input 1102 and on the pixels to be filtered 1101. The threshold and the measure are provided to a comparator 1130 and compared resulting in a decision on whether the blocking filtering is to be applied or not, in case the deblocking filtering is to be applied, the filter selection unit 1160 decides, possibly based on second threshold generated by a second threshold determining unit 1140 about a filter to be applied and provide a filter to the filtering unit 1170, which filters the pixel accordingly.

The filtering device 1100 may be employed as “deblocking filtering” 150 and/or 250 in the respective FIGS. 1 and 2 as a part of the encoder 100 and/or decoder 200.

The processing described in each of embodiments can be simply implemented in an independent computer system, by recording, in a recording medium, a program for implementing the configurations of the video coding method and the video decoding method described in each of embodiments. The recording media may be any recording media as long as the program can be recorded, such as a magnetic disk, an optical disk, a magnetic optical disk, an IC card, and a semiconductor memory.

The processing described in each of embodiments can be simply implemented in an independent computer system, by recording, in a recording medium, a program for implementing the configurations of the moving picture coding method (image coding method) and the moving picture decoding method (image decoding method) described in each of embodiments. The recording media may be any recording media as long as the program can be recorded, such as a magnetic disk, an optical disk, a magnetic optical disk, an IC card, and a semiconductor memory.

In the following, an embodiment denoted as Embodiment A will be described. The processing described in each of embodiments can be simply implemented in an independent computer system, by recording, in a recording medium, a program for implementing the configurations of the moving picture coding method (image coding method) and the moving picture decoding method (image decoding method) described in each of embodiments. The recording media may be any recording media as long as the program can be recorded, such as a magnetic disk, an optical disk, a magnetic optical disk, an IC card, and a semiconductor memory.

Hereinafter, the applications to the moving picture coding method (image coding method) and the moving picture decoding method (image decoding method) described in each of embodiments and systems using thereof will be described. The system has a feature of having an image coding and decoding apparatus that includes an image coding apparatus using the image coding method and an image decoding apparatus using the image decoding method. Other configurations in the system can be changed as appropriate depending on the cases.

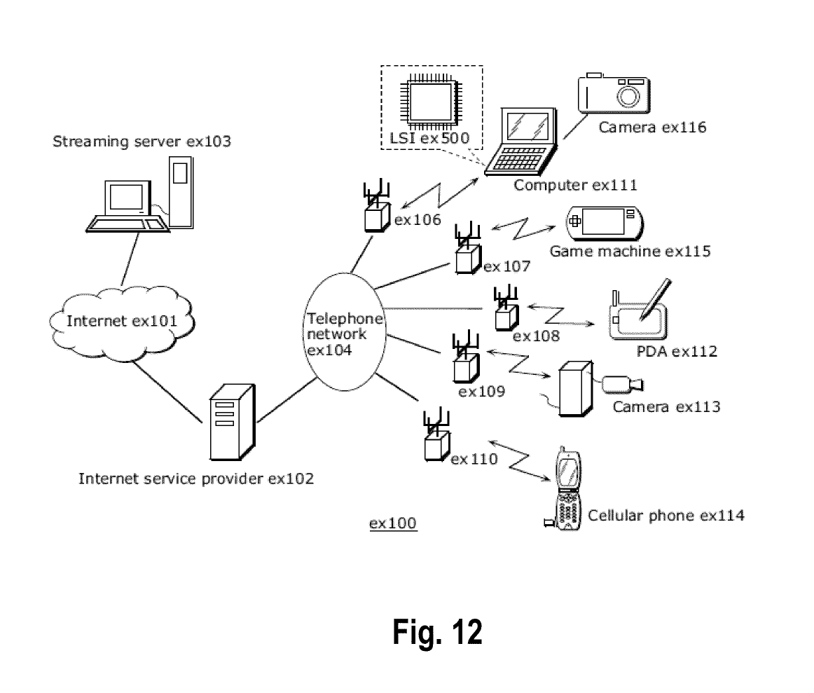

FIG. 12 illustrates an overall configuration of a content providing system ex100 for implementing content distribution services. The area for providing communication services is divided into cells of desired size, and base stations ex106, ex107, ex108, ex109, and ex110 which are fixed wireless stations are placed in each of the cells.

The content providing system ex100 is connected to devices, such as a computer ex111, a personal digital assistant (PDA) ex112, a camera ex113, a cellular phone ex114 and a game machine ex115, via the Internet ex101, an Internet service provider ex102, a telephone network ex104, as well as the base stations ex106 to ex110, respectively.

However, the configuration of the content providing system ex100 is not limited to the configuration shown in FIG. 12, and a combination in which any of the elements are connected is acceptable. In addition, each device may be directly connected to the telephone network ex104, rather than via the base stations ex106 to ex110 which are the fixed wireless stations. Furthermore, the devices may be interconnected to each other via a short distance wireless communication and others.

The camera ex113, such as a digital video camera, is capable of capturing video. A camera ex116, such as a digital camera, is capable of capturing both still images and video. Furthermore, the cellular phone ex114 may be the one that meets any of the standards such as Global System for Mobile Communications (GSM) (registered trademark), Code Division Multiple Access (CDMA), Wideband-Code Division Multiple Access (W-CDMA), Long Term Evolution (LTE), and High Speed Packet Access (HSPA). Alternatively, the cellular phone ex114 may be a Personal Handyphone System (PHS).

In the content providing system ex100, a streaming server ex103 is connected to the camera ex113 and others via the telephone network ex104 and the base station ex109, which enables distribution of images of a live show and others. In such a distribution, a content (for example, video of a music live show) captured by the user using the camera ex113 is coded as described above in each of embodiments (i.e., the camera functions as the image coding apparatus according to an aspect of the present invention), and the coded content is transmitted to the streaming server ex103. On the other hand, the streaming server ex103 carries out stream distribution of the transmitted content data to the clients upon their requests. The clients include the computer ex111, the PDA ex112, the camera ex113, the cellular phone ex114, and the game machine ex115 that are capable of decoding the above-mentioned coded data. Each of the devices that have received the distributed data decodes and reproduces the coded data (i.e., functions as the image decoding apparatus according to an aspect of the present invention).

The captured data may be coded by the camera ex113 or the streaming server ex103 that transmits the data, or the coding processes may be shared between the camera ex113 and the streaming server ex103. Similarly, the distributed data may be decoded by the clients or the streaming server ex103, or the decoding processes may be shared between the clients and the streaming server ex103. Furthermore, the data of the still images and video captured by not only the camera ex113 but also the camera ex116 may be transmitted to the streaming server ex103 through the computer ex111. The coding processes may be performed by the camera ex116, the computer ex111, or the streaming server ex103, or shared among them.

Furthermore, the coding and decoding processes may be performed by an LSI ex500 generally included in each of the computer ex111 and the devices. The LSI ex500 may be configured of a single chip or a plurality of chips. Software for coding and decoding video may be integrated into some type of a recording medium (such as a CD-ROM, a flexible disk, and a hard disk) that is readable by the computer ex111 and others, and the coding and decoding processes may be performed using the software. Furthermore, when the cellular phone ex114 is equipped with a camera, the video data obtained by the camera may be transmitted. The video data is data coded by the LSI ex500 included in the cellular phone ex114.

Furthermore, the streaming server ex103 may be composed of servers and computers, and may decentralize data and process the decentralized data, record, or distribute data.

As described above, the clients may receive and reproduce the coded data in the content providing system ex100. In other words, the clients can receive and decode information transmitted by the user, and reproduce the decoded data in real time in the content providing system ex100, so that the user who does not have any particular right and equipment can implement personal broadcasting.

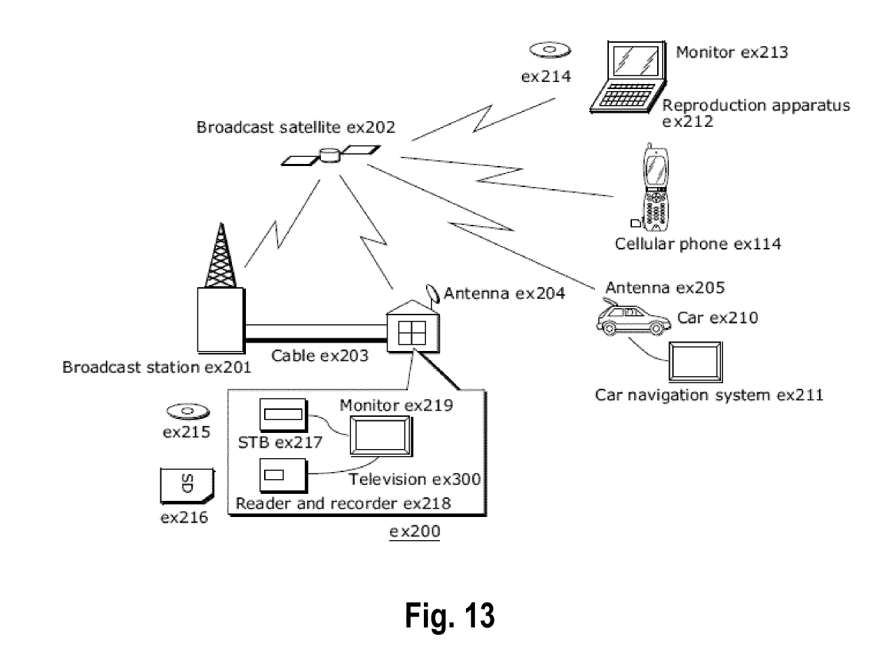

Aside from the example of the content providing system ex100, at least one of the moving picture coding apparatus (image coding apparatus) and the moving picture decoding apparatus (image decoding apparatus) described in each of embodiments may be implemented in a digital broadcasting system ex200 illustrated in FIG. 13. More specifically, a broadcast station ex201 communicates or transmits, via radio waves to a broadcast satellite ex202, multiplexed data obtained by multiplexing audio data and others onto video data. The video data is data coded by the moving picture coding method described in each of embodiments (i.e., data coded by the image coding apparatus according to an aspect of the present invention). Upon receipt of the multiplexed data, the broadcast satellite ex202 transmits radio waves for broadcasting. Then, a home-use antenna ex204 with a satellite broadcast reception function receives the radio waves. Next, a device such as a television (receiver) ex300 and a set top box (STB) ex217 decodes the received multiplexed data, and reproduces the decoded data (i.e., functions as the image decoding apparatus according to an aspect of the present invention).

Furthermore, a reader/recorder ex218 (i) reads and decodes the multiplexed data recorded on a recording medium ex215, such as a DVD and a BD, or (i) codes video signals in the recording medium ex215, and in some cases, writes data obtained by multiplexing an audio signal on the coded data. The reader/recorder ex218 can include the moving picture decoding apparatus or the moving picture coding apparatus as shown in each of embodiments. In this case, the reproduced video signals are displayed on the monitor ex219, and can be reproduced by another device or system using the recording medium ex215 on which the multiplexed data is recorded. It is also possible to implement the moving picture decoding apparatus in the set top box ex217 connected to the cable ex203 for a cable television or to the antenna ex204 for satellite and/or terrestrial broadcasting, so as to display the video signals on the monitor ex219 of the television ex300. The moving picture decoding apparatus may be implemented not in the set top box but in the television ex300.

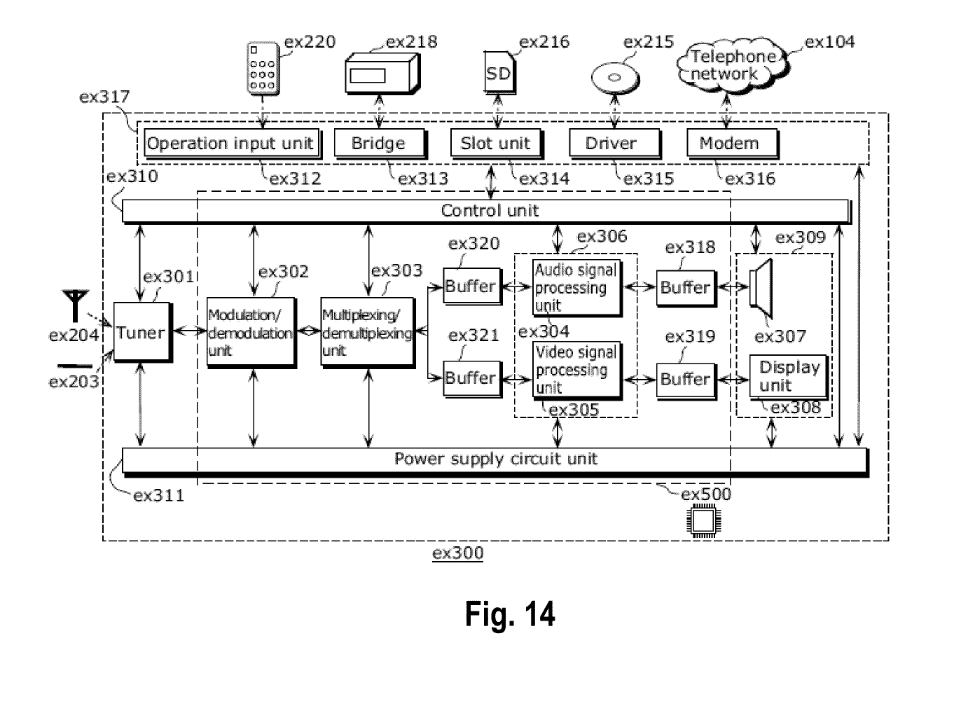

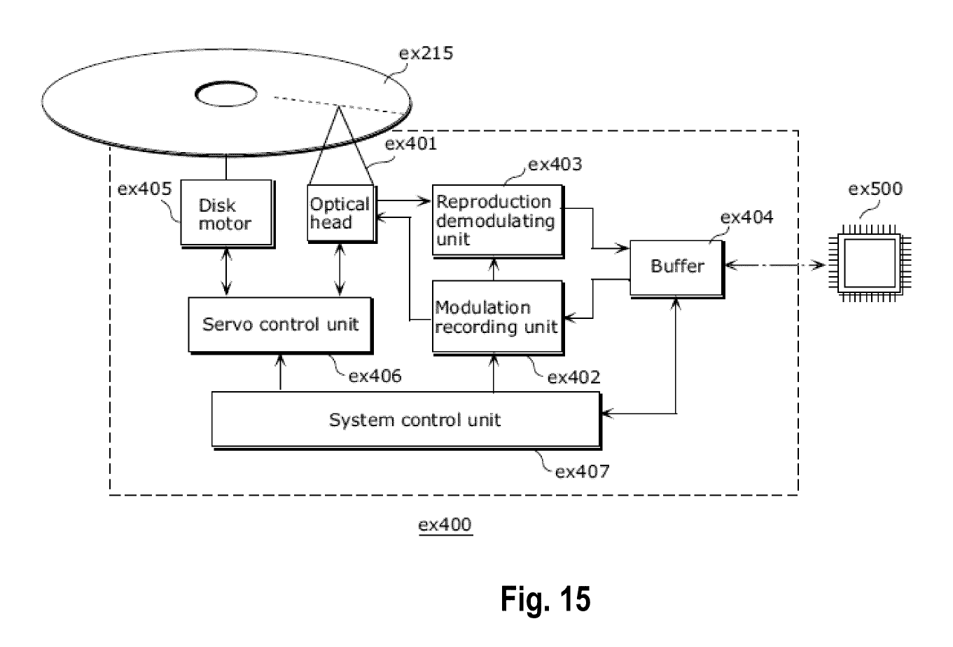

FIG. 14 illustrates the television (receiver) ex300 that uses the moving picture coding method and the moving picture decoding method described in each of embodiments. The television ex300 includes: a tuner ex301 that obtains or provides multiplexed data obtained by multiplexing audio data onto video data, through the antenna ex204 or the cable ex203, etc. that receives a broadcast; a modulation/demodulation unit ex302 that demodulates the received multiplexed data or modulates data into multiplexed data to be supplied outside; and a multiplexing/demultiplexing unit ex303 that demultiplexes the modulated multiplexed data into video data and audio data, or multiplexes video data and audio data coded by a signal processing unit ex306 into data.

The television ex300 further includes: a signal processing unit ex306 including an audio signal processing unit ex304 and a video signal processing unit ex305 that decode audio data and video data and code audio data and video data, respectively (which function as the image coding apparatus and the image decoding apparatus according to the aspects of the present invention); and an output unit ex309 including a speaker ex307 that provides the decoded audio signal, and a display unit ex308 that displays the decoded video signal, such as a display. Furthermore, the television ex300 includes an interface unit ex317 including an operation input unit ex312 that receives an input of a user operation. Furthermore, the television ex300 includes a control unit ex310 that controls overall each constituent element of the television ex300, and a power supply circuit unit ex311 that supplies power to each of the elements. Other than the operation input unit ex312, the interface unit ex317 may include: a bridge ex313 that is connected to an external device, such as the reader/recorder ex218; a slot unit ex314 for enabling attachment of the recording medium ex216, such as an SD card; a driver ex315 to be connected to an external recording medium, such as a hard disk; and a modem ex316 to be connected to a telephone network. Here, the recording medium ex216 can electrically record information using a non-volatile/volatile semiconductor memory element for storage. The constituent elements of the television ex300 are connected to each other through a synchronous bus.

First, the configuration in which the television ex300 decodes multiplexed data obtained from outside through the antenna ex204 and others and reproduces the decoded data will be described. In the television ex300, upon a user operation through a remote controller ex220 and others, the multiplexing/demultiplexing unit ex303 demultiplexes the multiplexed data demodulated by the modulation/demodulation unit ex302, under control of the control unit ex310 including a CPU. Furthermore, the audio signal processing unit ex304 decodes the demultiplexed audio data, and the video signal processing unit ex305 decodes the demultiplexed video data, using the decoding method described in each of embodiments, in the television ex300. The output unit ex309 provides the decoded video signal and audio signal outside, respectively. When the output unit ex309 provides the video signal and the audio signal, the signals may be temporarily stored in buffers ex318 and ex319, and others so that the signals are reproduced in synchronization with each other. Furthermore, the television ex300 may read multiplexed data not through a broadcast and others but from the recording media ex215 and ex216, such as a magnetic disk, an optical disk, and a SD card. Next, a configuration in which the television ex300 codes an audio signal and a video signal, and transmits the data outside or writes the data on a recording medium will be described. In the television ex300, upon a user operation through the remote controller ex220 and others, the audio signal processing unit ex304 codes an audio signal, and the video signal processing unit ex305 codes a video signal, under control of the control unit ex310 using the coding method described in each of embodiments. The multiplexing/demultiplexing unit ex303 multiplexes the coded video signal and audio signal, and provides the resulting signal outside. When the multiplexing/demultiplexing unit ex303 multiplexes the video signal and the audio signal, the signals may be temporarily stored in the buffers ex320 and ex321, and others so that the signals are reproduced in synchronization with each other. Here, the buffers ex318, ex319, ex320, and ex321 may be plural as illustrated, or at least one buffer may be shared in the television ex300. Furthermore, data may be stored in a buffer so that the system overflow and underflow may be avoided between the modulation/demodulation unit ex302 and the multiplexing/demultiplexing unit ex303, for example.

Furthermore, the television ex300 may include a configuration for receiving an AV input from a microphone or a camera other than the configuration for obtaining audio and video data from a broadcast or a recording medium, and may code the obtained data. Although the television ex300 can code, multiplex, and provide outside data in the description, it may be capable of only receiving, decoding, and providing outside data but not the coding, multiplexing, and providing outside data.

Furthermore, when the reader/recorder ex218 reads or writes multiplexed data from or on a recording medium, one of the television ex300 and the reader/recorder ex218 may decode or code the multiplexed data, and the television ex300 and the reader/recorder ex218 may share the decoding or coding.

As an example, FIG. 15 illustrates a configuration of an information reproducing/recording unit ex400 when data is read or written from or on an optical disk. The information reproducing/recording unit ex400 includes constituent elements ex401, ex402, ex403, ex404, ex405, ex406, and ex407 to be described hereinafter. The optical head ex401 irradiates a laser spot in a recording surface of the recording medium ex215 that is an optical disk to write information, and detects reflected light from the recording surface of the recording medium ex215 to read the information. The modulation recording unit ex402 electrically drives a semiconductor laser included in the optical head ex401, and modulates the laser light according to recorded data. The reproduction demodulating unit ex403 amplifies a reproduction signal obtained by electrically detecting the reflected light from the recording surface using a photo detector included in the optical head ex401, and demodulates the reproduction signal by separating a signal component recorded on the recording medium ex215 to reproduce the necessary information. The buffer ex404 temporarily holds the information to be recorded on the recording medium ex215 and the information reproduced from the recording medium ex215. The disk motor ex405 rotates the recording medium ex215. The servo control unit ex406 moves the optical head ex401 to a predetermined information track while controlling the rotation drive of the disk motor ex405 so as to follow the laser spot. The system control unit ex407 controls overall the information reproducing/recording unit ex400. The reading and writing processes can be implemented by the system control unit ex407 using various information stored in the buffer ex404 and generating and adding new information as necessary, and by the modulation recording unit ex402, the reproduction demodulating unit ex403, and the servo control unit ex406 that record and reproduce information through the optical head ex401 while being operated in a coordinated manner. The system control unit ex407 includes, for example, a microprocessor, and executes processing by causing a computer to execute a program for read and write.

Although the optical head ex401 irradiates a laser spot in the description, it may perform high-density recording using near field light.

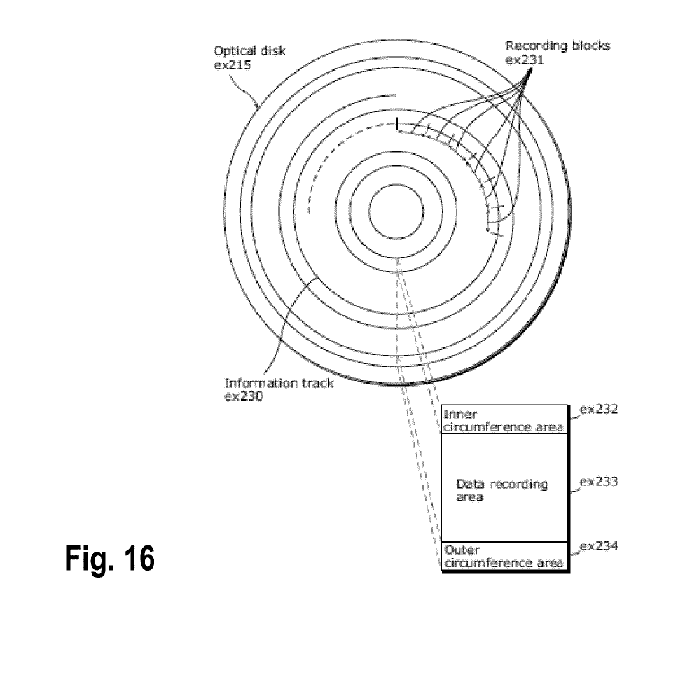

FIG. 16 illustrates the recording medium ex215 that is the optical disk. On the recording surface of the recording medium ex215, guide grooves are spirally formed, and an information track ex230 records, in advance, address information indicating an absolute position on the disk according to change in a shape of the guide grooves. The address information includes information for determining positions of recording blocks ex231 that are a unit for recording data. Reproducing the information track ex230 and reading the address information in an apparatus that records and reproduces data can lead to determination of the positions of the recording blocks. Furthermore, the recording medium ex215 includes a data recording area ex233, an inner circumference area ex232, and an outer circumference area ex234. The data recording area ex233 is an area for use in recording the user data. The inner circumference area ex232 and the outer circumference area ex234 that are inside and outside of the data recording area ex233, respectively are for specific use except for recording the user data. The information reproducing/recording unit 400 reads and writes coded audio, coded video data, or multiplexed data obtained by multiplexing the coded audio and video data, from and on the data recording area ex233 of the recording medium ex215.

Although an optical disk having a layer, such as a DVD and a BD is described as an example in the description, the optical disk is not limited to such, and may be an optical disk having a multilayer structure and capable of being recorded on a part other than the surface. Furthermore, the optical disk may have a structure for multidimensional recording/reproduction, such as recording of information using light of colors with different wavelengths in the same portion of the optical disk and for recording information having different layers from various angles.

Furthermore, a car ex210 having an antenna ex205 can receive data from the satellite ex202 and others, and reproduce video on a display device such as a car navigation system ex211 set in the car ex210, in the digital broadcasting system ex200. Here, a configuration of the car navigation system ex211 will be a configuration, for example, including a GPS receiving unit from the configuration illustrated in FIG. 112. The same will be true for the configuration of the computer ex111, the cellular phone ex114, and others.

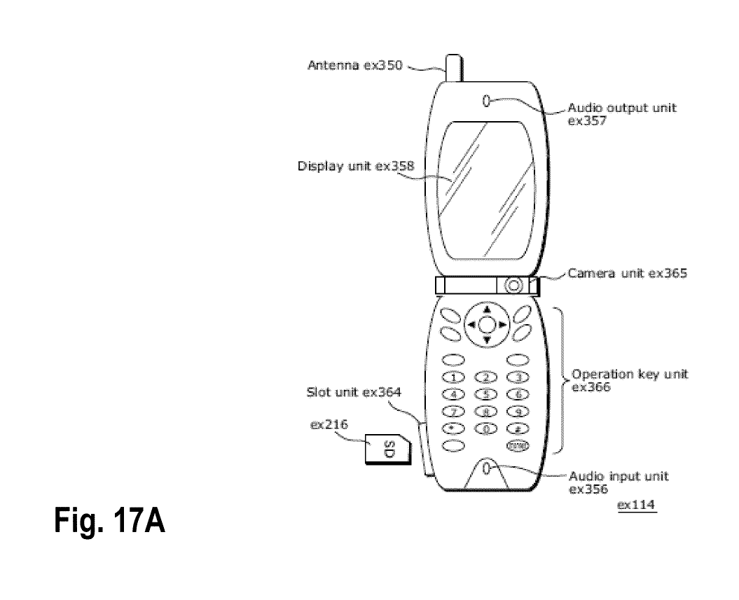

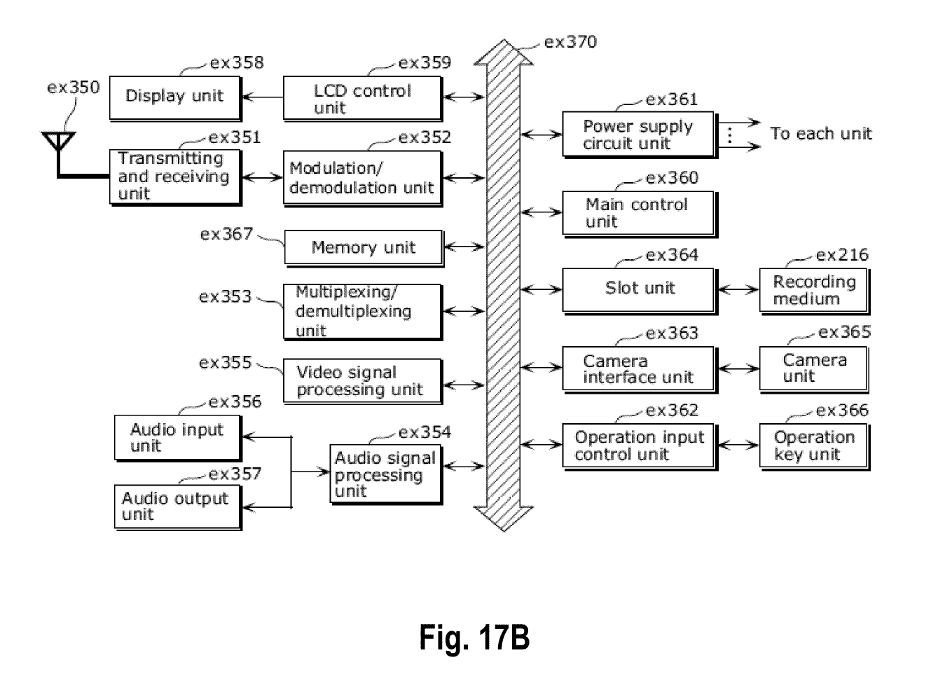

FIG. 17A illustrates the cellular phone ex114 that uses the moving picture coding method and the moving picture decoding method described in embodiments. The cellular phone ex114 includes: an antenna ex350 for transmitting and receiving radio waves through the base station ex110; a camera unit ex365 capable of capturing moving and still images; and a display unit ex358 such as a liquid crystal display for displaying the data such as decoded video captured by the camera unit ex365 or received by the antenna ex350. The cellular phone ex114 further includes: a main body unit including an operation key unit ex366; an audio output unit ex357 such as a speaker for output of audio; an audio input unit ex356 such as a microphone for input of audio; a memory unit ex367 for storing captured video or still pictures, recorded audio, coded or decoded data of the received video, the still pictures, e-mails, or others; and a slot unit ex364 that is an interface unit for a recording medium that stores data in the same manner as the memory unit ex367.

Next, an example of a configuration of the cellular phone ex114 will be described with reference to FIG. 17B. In the cellular phone ex114, a main control unit ex360 designed to control overall each unit of the main body including the display unit ex358 as well as the operation key unit ex366 is connected mutually, via a synchronous bus ex370, to a power supply circuit unit ex361, an operation input control unit ex362, a video signal processing unit ex355, a camera interface unit ex363, a liquid crystal display (LCD) control unit ex359, a modulation/demodulation unit ex352, a multiplexing/demultiplexing unit ex353, an audio signal processing unit ex354, the slot unit ex364, and the memory unit ex367.

When a call-end key or a power key is turned ON by a user's operation, the power supply circuit unit ex361 supplies the respective units with power from a battery pack so as to activate the cell phone ex114.

In the cellular phone ex114, the audio signal processing unit ex354 converts the audio signals collected by the audio input unit ex356 in voice conversation mode into digital audio signals under the control of the main control unit ex360 including a CPU, ROM, and RAM. Then, the modulation/demodulation unit ex352 performs spread spectrum processing on the digital audio signals, and the transmitting and receiving unit ex351 performs digital-to-analog conversion and frequency conversion on the data, so as to transmit the resulting data via the antenna ex350. Also, in the cellular phone ex114, the transmitting and receiving unit ex351 amplifies the data received by the antenna ex350 in voice conversation mode and performs frequency conversion and the analog-to-digital conversion on the data. Then, the modulation/demodulation unit ex352 performs inverse spread spectrum processing on the data, and the audio signal processing unit ex354 converts it into analog audio signals, so as to output them via the audio output unit ex357.

Furthermore, when an e-mail in data communication mode is transmitted, text data of the e-mail inputted by operating the operation key unit ex366 and others of the main body is sent out to the main control unit ex360 via the operation input control unit ex362. The main control unit ex360 causes the modulation/demodulation unit ex352 to perform spread spectrum processing on the text data, and the transmitting and receiving unit ex351 performs the digital-to-analog conversion and the frequency conversion on the resulting data to transmit the data to the base station ex110 via the antenna ex350. When an e-mail is received, processing that is approximately inverse to the processing for transmitting an e-mail is performed on the received data, and the resulting data is provided to the display unit ex358.

When video, still images, or video and audio in data communication mode is or are transmitted, the video signal processing unit ex355 compresses and codes video signals supplied from the camera unit ex365 using the moving picture coding method shown in each of embodiments (i.e., functions as the image coding apparatus according to the aspect of the present invention), and transmits the coded video data to the multiplexing/demultiplexing unit ex353. In contrast, during when the camera unit ex365 captures video, still images, and others, the audio signal processing unit ex354 codes audio signals collected by the audio input unit ex356, and transmits the coded audio data to the multiplexing/demultiplexing unit ex353.

The multiplexing/demultiplexing unit ex353 multiplexes the coded video data supplied from the video signal processing unit ex355 and the coded audio data supplied from the audio signal processing unit ex354, using a predetermined method. Then, the modulation/demodulation unit (modulation/demodulation circuit unit) ex352 performs spread spectrum processing on the multiplexed data, and the transmitting and receiving unit ex351 performs digital-to-analog conversion and frequency conversion on the data so as to transmit the resulting data via the antenna ex350.

When receiving data of a video file which is linked to a Web page and others in data communication mode or when receiving an e-mail with video and/or audio attached, in order to decode the multiplexed data received via the antenna ex350, the multiplexing/demultiplexing unit ex353 demultiplexes the multiplexed data into a video data bit stream and an audio data bit stream, and supplies the video signal processing unit ex355 with the coded video data and the audio signal processing unit ex354 with the coded audio data, through the synchronous bus ex370. The video signal processing unit ex355 decodes the video signal using a moving picture decoding method corresponding to the moving picture coding method shown in each of embodiments (i.e., functions as the image decoding apparatus according to the aspect of the present invention), and then the display unit ex358 displays, for instance, the video and still images included in the video file linked to the Web page via the LCD control unit ex359. Furthermore, the audio signal processing unit ex354 decodes the audio signal, and the audio output unit ex357 provides the audio.

Furthermore, similarly to the television ex300, a terminal such as the cellular phone ex114 probably have 3 types of implementation configurations including not only (i) a transmitting and receiving terminal including both a coding apparatus and a decoding apparatus, but also (ii) a transmitting terminal including only a coding apparatus and (iii) a receiving terminal including only a decoding apparatus. Although the digital broadcasting system ex200 receives and transmits the multiplexed data obtained by multiplexing audio data onto video data in the description, the multiplexed data may be data obtained by multiplexing not audio data but character data related to video onto video data, and may be not multiplexed data but video data itself.

As such, the moving picture coding method and the moving picture decoding method in each of embodiments can be used in any of the devices and systems described. Thus, the advantages described in each of embodiments can be obtained.

Furthermore, the present invention is not limited to embodiments, and various modifications and revisions are possible without departing from the scope of the present invention.

In the following, embodiment denoted as Embodiment B will be described. Video data can be generated by switching, as necessary, between (i) the moving picture coding method or the moving picture coding apparatus shown in each of embodiments and (ii) a moving picture coding method or a moving picture coding apparatus in conformity with a different standard, such as MPEG-2, MPEG-4 AVC, and VC-1.

Here, when a plurality of video data that conforms to the different standards is generated and is then decoded, the decoding methods need to be selected to conform to the different standards. However, since to which standard each of the plurality of the video data to be decoded conform cannot be detected, there is a problem that an appropriate decoding method cannot be selected.

In order to solve the problem, multiplexed data obtained by multiplexing audio data and others onto video data has a structure including identification information indicating to which standard the video data conforms. The specific structure of the multiplexed data including the video data generated in the moving picture coding method and by the moving picture coding apparatus shown in each of embodiments will be hereinafter described. The multiplexed data is a digital stream in the MPEG-2 Transport Stream format.

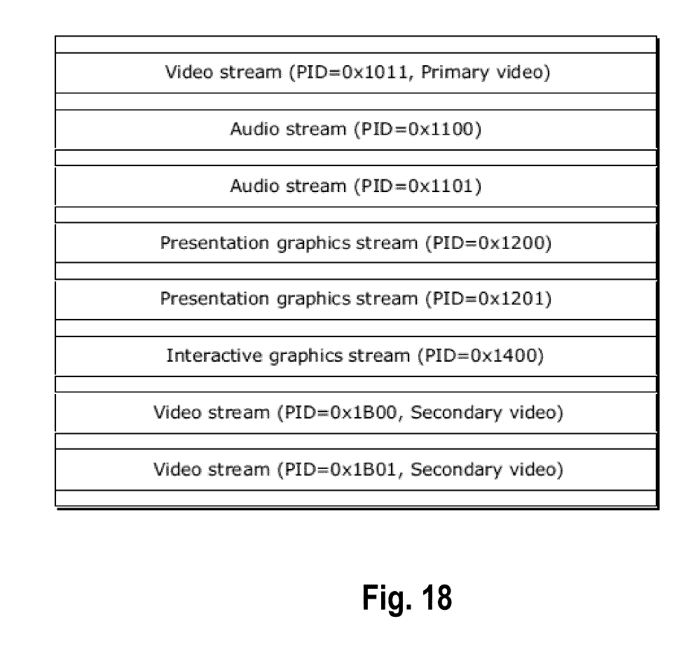

FIG. 18 illustrates a structure of the multiplexed data. As illustrated in FIG. 116, the multiplexed data can be obtained by multiplexing at least one of a video stream, an audio stream, a presentation graphics stream (PG), and an interactive graphics stream. The video stream represents primary video and secondary video of a movie, the audio stream (IG) represents a primary audio part and a secondary audio part to be mixed with the primary audio part, and the presentation graphics stream represents subtitles of the movie. Here, the primary video is normal video to be displayed on a screen, and the secondary video is video to be displayed on a smaller window in the primary video. Furthermore, the interactive graphics stream represents an interactive screen to be generated by arranging the GUI components on a screen. The video stream is coded in the moving picture coding method or by the moving picture coding apparatus shown in each of embodiments, or in a moving picture coding method or by a moving picture coding apparatus in conformity with a conventional standard, such as MPEG-2, MPEG-4 AVC, and VC-1. The audio stream is coded in accordance with a standard, such as Dolby-AC-3, Dolby Digital Plus, MLP, DTS, DTS-HD, and linear PCM.

Each stream included in the multiplexed data is identified by PID. For example, 0x1011 is allocated to the video stream to be used for video of a movie, 0x1100 to 0x111F are allocated to the audio streams, 0x1200 to 0x121F are allocated to the presentation graphics streams, 0x1400 to 0x141F are allocated to the interactive graphics streams, 0x1B00 to 0x1B1F are allocated to the video streams to be used for secondary video of the movie, and 0x1A00 to 0x1A1F are allocated to the audio streams to be used for the secondary audio to be mixed with the primary audio.

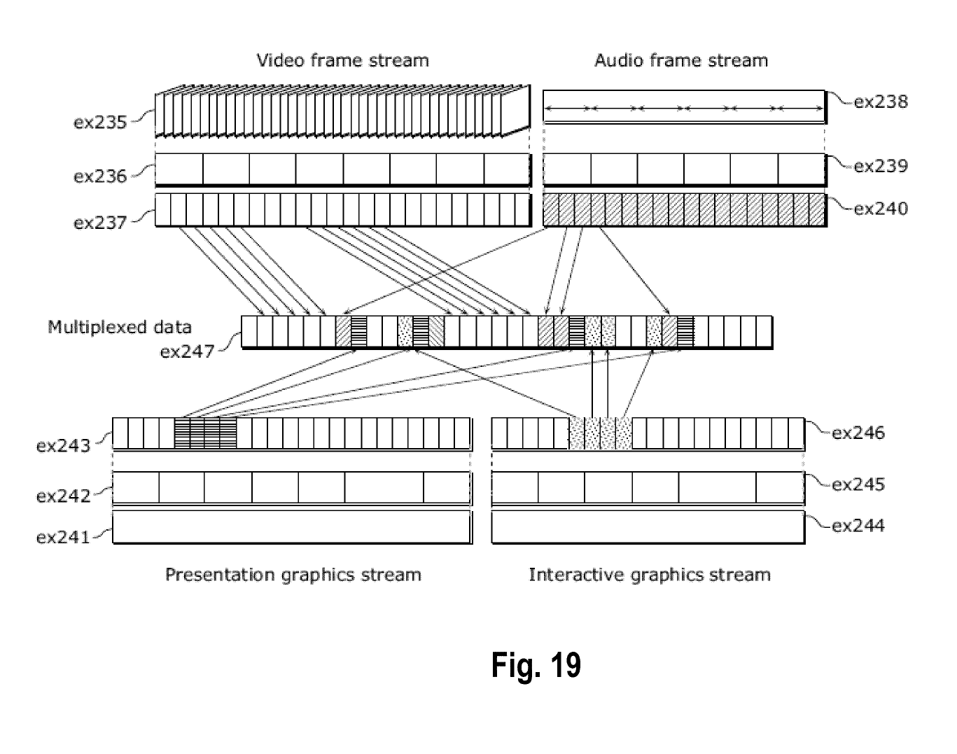

FIG. 19 schematically illustrates how data is multiplexed. First, a video stream ex235 composed of video frames and an audio stream ex238 composed of audio frames are transformed into a stream of PES packets ex236 and a stream of PES packets ex239, and further into TS packets ex237 and TS packets ex240, respectively. Similarly, data of a presentation graphics stream ex241 and data of an interactive graphics stream ex244 are transformed into a stream of PES packets ex242 and a stream of PES packets ex245, and further into TS packets ex243 and TS packets ex246, respectively. These TS packets are multiplexed into a stream to obtain multiplexed data ex247.

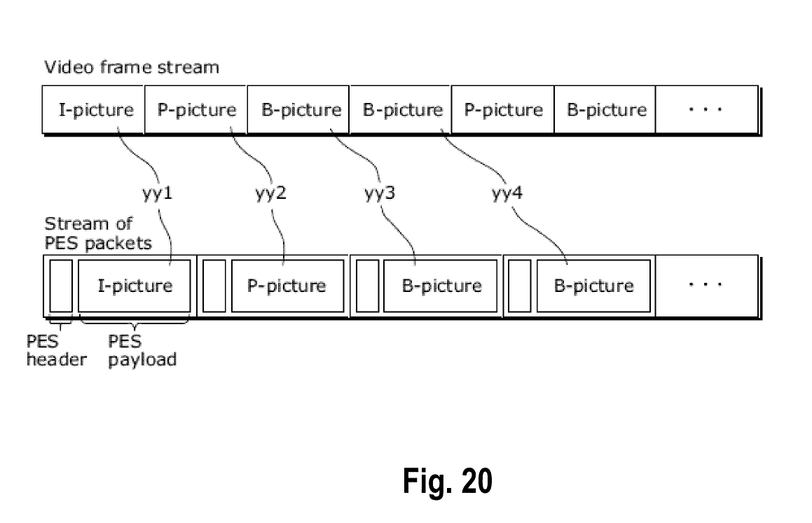

FIG. 20 illustrates how a video stream is stored in a stream of PES packets in more detail. The first bar in FIG. 20 shows a video frame stream in a video stream. The second bar shows the stream of PES packets. As indicated by arrows denoted as yy1, yy2, yy3, and yy4 in FIG. 20, the video stream is divided into pictures as I pictures, B pictures, and P pictures each of which is a video presentation unit, and the pictures are stored in a payload of each of the PES packets. Each of the PES packets has a PES header, and the PES header stores a Presentation Time-Stamp (PTS) indicating a display time of the picture, and a Decoding Time-Stamp (DTS) indicating a decoding time of the picture.

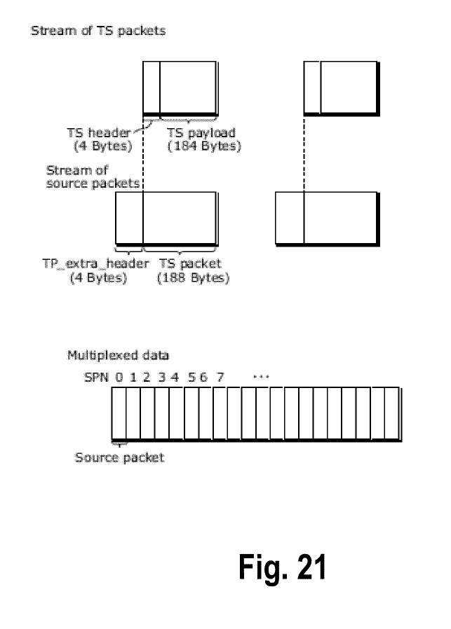

FIG. 21 illustrates a format of TS packets to be finally written on the multiplexed data. Each of the TS packets is a 188-byte fixed length packet including a 4-byte TS header having information, such as a PID for identifying a stream and a 184-byte TS payload for storing data. The PES packets are divided, and stored in the TS payloads, respectively. When a BD ROM is used, each of the TS packets is given a 4-byte TP Extra Header, thus resulting in 192-byte source packets. The source packets are written on the multiplexed data. The TP Extra Header stores information such as an Arrival Time Stamp (ATS). The ATS shows a transfer start time at which each of the TS packets is to be transferred to a PID filter. The source packets are arranged in the multiplexed data as shown at the bottom of FIG. 21. The numbers incrementing from the head of the multiplexed data are called source packet numbers (SPNs).

Each of the TS packets included in the multiplexed data includes not only streams of audio, video, subtitles and others, but also a Program Association Table (PAT), a Program Map Table (PMT), and a Program Clock Reference (PCR). The PAT shows what a PID in a PMT used in the multiplexed data indicates, and a PID of the PAT itself is registered as zero. The PMT stores PIDs of the streams of video, audio, subtitles and others included in the multiplexed data, and attribute information of the streams corresponding to the PIDs. The PMT also has various descriptors relating to the multiplexed data. The descriptors have information such as copy control information showing whether copying of the multiplexed data is permitted or not. The PCR stores STC time information corresponding to an ATS showing when the PCR packet is transferred to a decoder, in order to achieve synchronization between an Arrival Time Clock (ATC) that is a time axis of ATSs, and an System Time Clock (STC) that is a time axis of PTSs and DTSs.

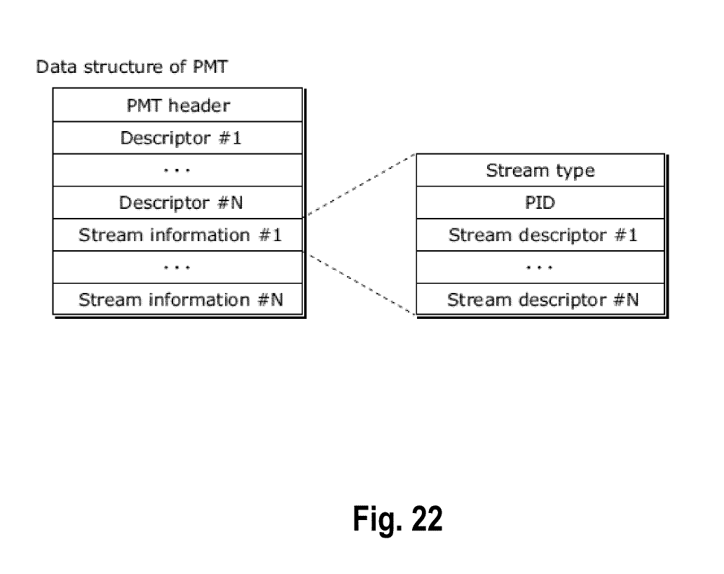

FIG. 22 illustrates the data structure of the PMT in detail. A PMT header is disposed at the top of the PMT. The PMT header describes the length of data included in the PMT and others. A plurality of descriptors relating to the multiplexed data is disposed after the PMT header. Information such as the copy control information is described in the descriptors. After the descriptors, a plurality of pieces of stream information relating to the streams included in the multiplexed data is disposed. Each piece of stream information includes stream descriptors each describing information, such as a stream type for identifying a compression codec of a stream, a stream PID, and stream attribute information (such as a frame rate or an aspect ratio). The stream descriptors are equal in number to the number of streams in the multiplexed data.

When the multiplexed data is recorded on a recording medium and others, it is recorded together with multiplexed data information files.

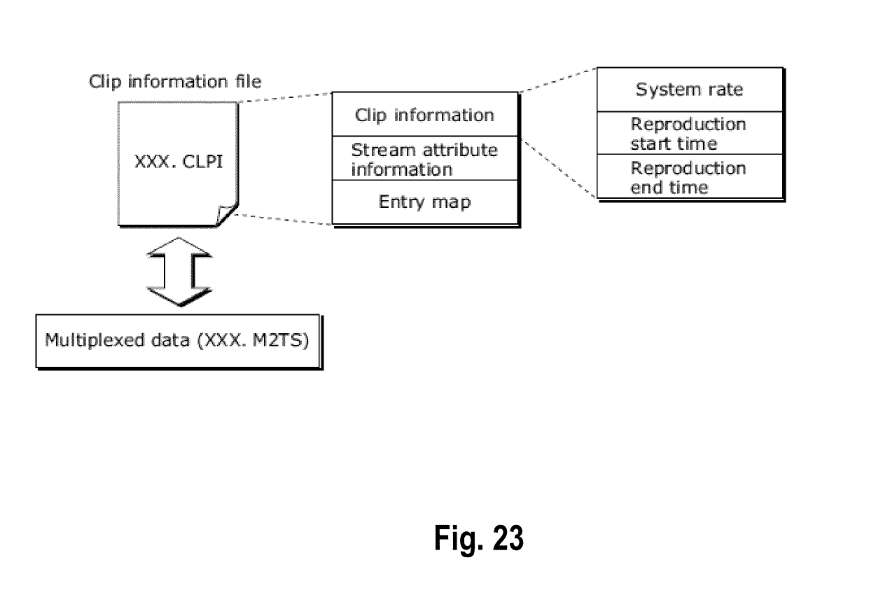

Each of the multiplexed data information files is management information of the multiplexed data as shown in FIG. 23. The multiplexed data information files are in one to one correspondence with the multiplexed data, and each of the files includes multiplexed data information, stream attribute information, and an entry map.

As illustrated in FIG. 23, the multiplexed data information includes a system rate, a reproduction start time, and a reproduction end time. The system rate indicates the maximum transfer rate at which a system target decoder to be described later transfers the multiplexed data to a PID filter. The intervals of the ATSs included in the multiplexed data are set to not higher than a system rate. The reproduction start time indicates a PTS in a video frame at the head of the multiplexed data. An interval of one frame is added to a PTS in a video frame at the end of the multiplexed data, and the PTS is set to the reproduction end time.

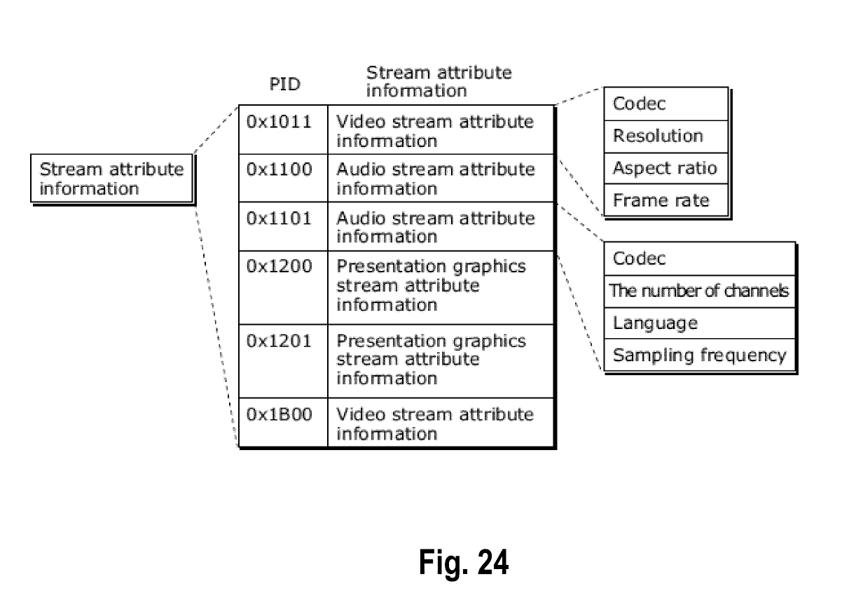

As shown in FIG. 24, a piece of attribute information is registered in the stream attribute information, for each PID of each stream included in the multiplexed data. Each piece of attribute information has different information depending on whether the corresponding stream is a video stream, an audio stream, a presentation graphics stream, or an interactive graphics stream. Each piece of video stream attribute information carries information including what kind of compression codec is used for compressing the video stream, and the resolution, aspect ratio and frame rate of the pieces of picture data that is included in the video stream. Each piece of audio stream attribute information carries information including what kind of compression codec is used for compressing the audio stream, how many channels are included in the audio stream, which language the audio stream supports, and how high the sampling frequency is. The video stream attribute information and the audio stream attribute information are used for initialization of a decoder before the player plays back the information.

In the present embodiment, the multiplexed data to be used is of a stream type included in the PMT. Furthermore, when the multiplexed data is recorded on a recording medium, the video stream attribute information included in the multiplexed data information is used. More specifically, the moving picture coding method or the moving picture coding apparatus described in each of embodiments includes a step or a unit for allocating unique information indicating video data generated by the moving picture coding method or the moving picture coding apparatus in each of embodiments, to the stream type included in the PMT or the video stream attribute information. With the configuration, the video data generated by the moving picture coding method or the moving picture coding apparatus described in each of embodiments can be distinguished from video data that conforms to another standard.

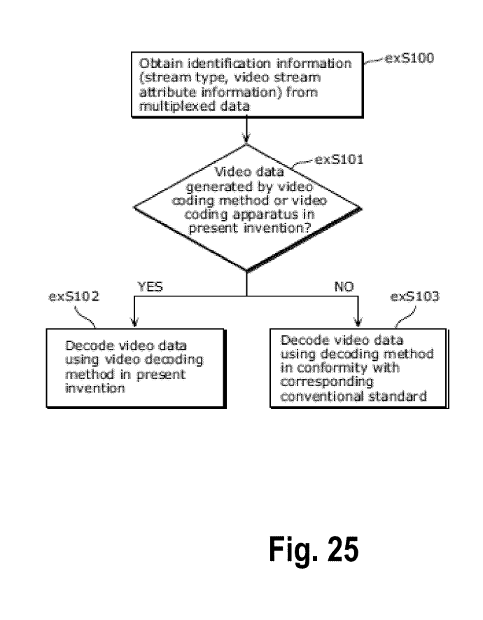

Furthermore, FIG. 25 illustrates steps of the moving picture decoding method according to the present embodiment. In Step exS100, the stream type included in the PMT or the video stream attribute information included in the multiplexed data information is obtained from the multiplexed data. Next, in Step exS101, it is determined whether or not the stream type or the video stream attribute information indicates that the multiplexed data is generated by the moving picture coding method or the moving picture coding apparatus in each of embodiments. When it is determined that the stream type or the video stream attribute information indicates that the multiplexed data is generated by the moving picture coding method or the moving picture coding apparatus in each of embodiments, in Step exS102, decoding is performed by the moving picture decoding method in each of embodiments. Furthermore, when the stream type or the video stream attribute information indicates conformance to the conventional standards, such as MPEG-2, MPEG-4 AVC, and VC-1, in Step exS103, decoding is performed by a moving picture decoding method in conformity with the conventional standards.

As such, allocating a new unique value to the stream type or the video stream attribute information enables determination whether or not the moving picture decoding method or the moving picture decoding apparatus that is described in each of embodiments can perform decoding. Even when multiplexed data that conforms to a different standard is input, an appropriate decoding method or apparatus can be selected. Thus, it becomes possible to decode information without any error. Furthermore, the moving picture coding method or apparatus, or the moving picture decoding method or apparatus in the present embodiment can be used in the devices and systems described above.

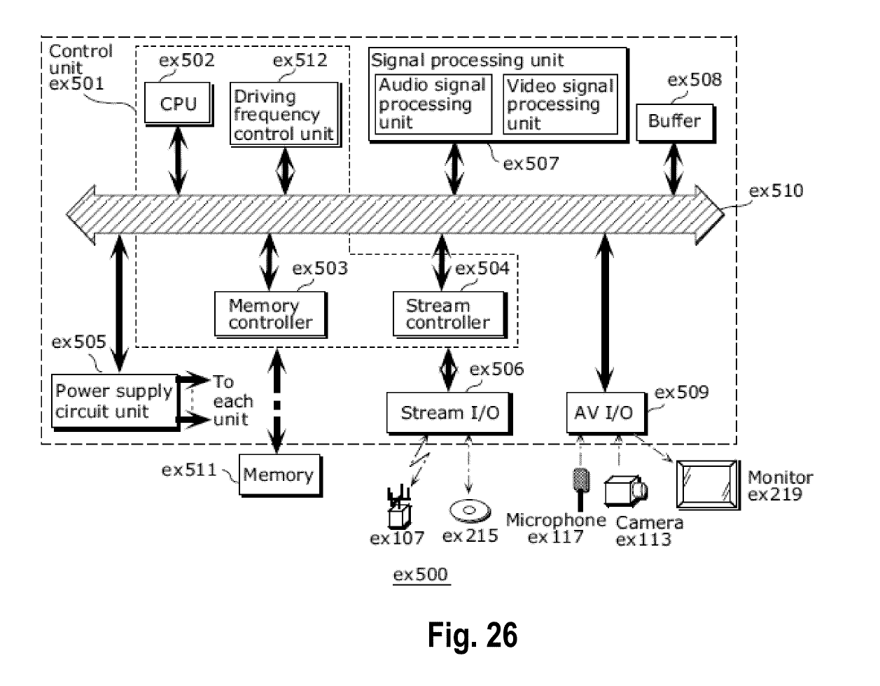

In the following an embodiment denoted as Embodiment C is described. Each of the moving picture coding method, the moving picture coding apparatus, the moving picture decoding method, and the moving picture decoding apparatus in each of embodiments is typically achieved in the form of an integrated circuit or a Large Scale Integrated (LSI) circuit. As an example of the LSI, FIG. 26 illustrates a configuration of the LSI ex500 that is made into one chip. The LSI ex500 includes elements ex501, ex502, ex503, ex504, ex505, ex506, ex507, ex508, and ex509 to be described below, and the elements are connected to each other through a bus ex510. The power supply circuit unit ex505 is activated by supplying each of the elements with power when the power supply circuit unit ex505 is turned on.

For example, when coding is performed, the LSI ex500 receives an AV signal from a microphone ex117, a camera ex113, and others through an AV IO ex509 under control of a control unit ex501 including a CPU ex502, a memory controller ex503, a stream controller ex504, and a driving frequency control unit ex512. The received AV signal is temporarily stored in an external memory ex511, such as an SDRAM. Under control of the control unit ex501, the stored data is segmented into data portions according to the processing amount and speed to be transmitted to a signal processing unit ex507. Then, the signal processing unit ex507 codes an audio signal and/or a video signal. Here, the coding of the video signal is the coding described in each of embodiments. Furthermore, the signal processing unit ex507 sometimes multiplexes the coded audio data and the coded video data, and a stream IO ex506 provides the multiplexed data outside. The provided multiplexed data is transmitted to the base station ex107, or written on the recording medium ex215. When data sets are multiplexed, the data should be temporarily stored in the buffer ex508 so that the data sets are synchronized with each other.

Although the memory ex511 is an element outside the LSI ex500, it may be included in the LSI ex500. The buffer ex508 is not limited to one buffer, but may be composed of buffers. Furthermore, the LSI ex500 may be made into one chip or a plurality of chips.

Furthermore, although the control unit ex501 includes the CPU ex502, the memory controller ex503, the stream controller ex504, the driving frequency control unit ex512, the configuration of the control unit ex501 is not limited to such. For example, the signal processing unit ex507 may further include a CPU. Inclusion of another CPU in the signal processing unit ex507 can improve the processing speed. Furthermore, as another example, the CPU ex502 may serve as or be a part of the signal processing unit ex507, and, for example, may include an audio signal processing unit. In such a case, the control unit ex501 includes the signal processing unit ex507 or the CPU ex502 including a part of the signal processing unit ex507.

The name used here is LSI, but it may also be called IC, system LSI, super LSI, or ultra LSI depending on the degree of integration.

Moreover, ways to achieve integration are not limited to the LSI, and a special circuit or a general purpose processor and so forth can also achieve the integration. Field Programmable Gate Array (FPGA) that can be programmed after manufacturing LSIs or a reconfigurable processor that allows re-configuration of the connection or configuration of an LSI can be used for the same purpose.

In the future, with advancement in semiconductor technology, a brand-new technology may replace LSI. The functional blocks can be integrated using such a technology. The possibility is that the present invention is applied to biotechnology.

In the following an embodiment described as Embodiment D is described. When video data generated in the moving picture coding method or by the moving picture coding apparatus described in each of embodiments is decoded, compared to when video data that conforms to a conventional standard, such as MPEG-2, MPEG-4 AVC, and VC-1 is decoded, the processing amount probably increases. Thus, the LSI ex500 needs to be set to a driving frequency higher than that of the CPU ex502 to be used when video data in conformity with the conventional standard is decoded. However, when the driving frequency is set higher, there is a problem that the power consumption increases.

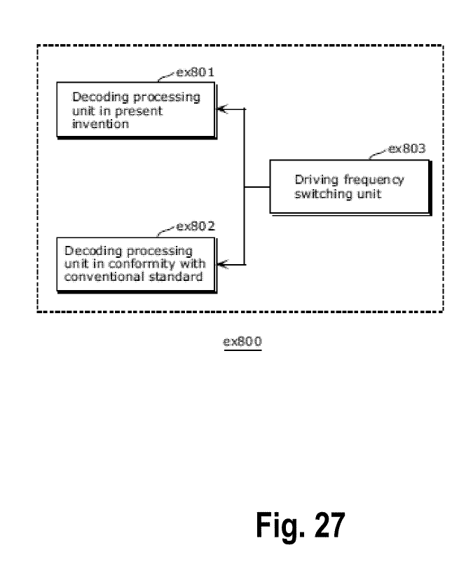

In order to solve the problem, the moving picture decoding apparatus, such as the television ex300 and the LSI ex500 is configured to determine to which standard the video data conforms, and switch between the driving frequencies according to the determined standard. FIG. 27 illustrates a configuration ex800 in the present embodiment. A driving frequency switching unit ex803 sets a driving frequency to a higher driving frequency when video data is generated by the moving picture coding method or the moving picture coding apparatus described in each of embodiments. Then, the driving frequency switching unit ex803 instructs a decoding processing unit ex801 that executes the moving picture decoding method described in each of embodiments to decode the video data. When the video data conforms to the conventional standard, the driving frequency switching unit ex803 sets a driving frequency to a lower driving frequency than that of the video data generated by the moving picture coding method or the moving picture coding apparatus described in each of embodiments. Then, the driving frequency switching unit ex803 instructs the decoding processing unit ex802 that conforms to the conventional standard to decode the video data.

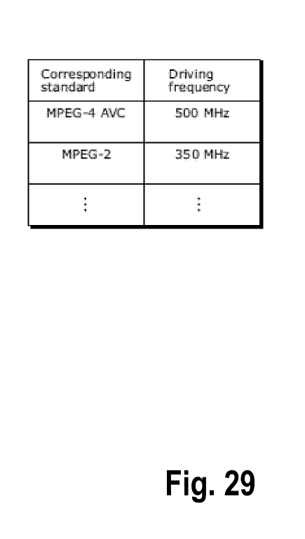

More specifically, the driving frequency switching unit ex803 includes the CPU ex502 and the driving frequency control unit ex512 in FIG. 124. Here, each of the decoding processing unit ex801 that executes the moving picture decoding method described in each of embodiments and the decoding processing unit ex802 that conforms to the conventional standard corresponds to the signal processing unit ex507 in FIG. 26. The CPU ex502 determines to which standard the video data conforms. Then, the driving frequency control unit ex512 determines a driving frequency based on a signal from the CPU ex502. Furthermore, the signal processing unit ex507 decodes the video data based on the signal from the CPU ex502. For example, the identification information described in Embodiment B is probably used for identifying the video data. The identification information is not limited to the one described in Embodiment B but may be any information as long as the information indicates to which standard the video data conforms. For example, when which standard video data conforms to can be determined based on an external signal for determining that the video data is used for a television or a disk, etc., the determination may be made based on such an external signal. Furthermore, the CPU ex502 selects a driving frequency based on, for example, a look-up table in which the standards of the video data are associated with the driving frequencies as shown in FIG. 29. The driving frequency can be selected by storing the look-up table in the buffer ex508 and in an internal memory of an LSI, and with reference to the look-up table by the CPU ex502.

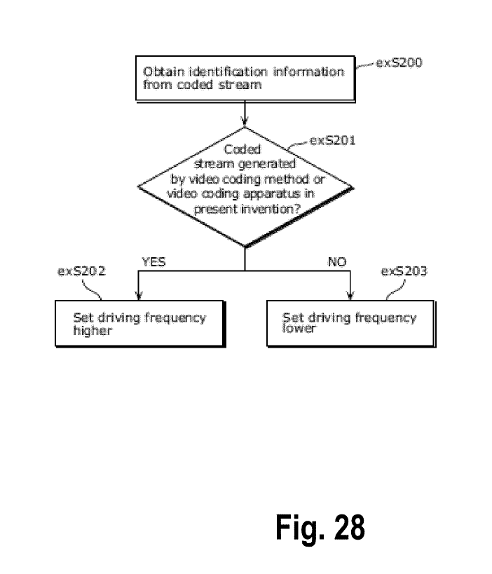

FIG. 28 illustrates steps for executing a method in the present embodiment. First, in Step exS200, the signal processing unit ex507 obtains identification information from the multiplexed data. Next, in Step exS201, the CPU ex502 determines whether or not the video data is generated by the coding method and the coding apparatus described in each of embodiments, based on the identification information. When the video data is generated by the moving picture coding method and the moving picture coding apparatus described in each of embodiments, in Step exS202, the CPU ex502 transmits a signal for setting the driving frequency to a higher driving frequency to the driving frequency control unit ex512. Then, the driving frequency control unit ex512 sets the driving frequency to the higher driving frequency. On the other hand, when the identification information indicates that the video data conforms to the conventional standard, such as MPEG-2, MPEG-4 AVC, and VC-1, in Step exS203, the CPU ex502 transmits a signal for setting the driving frequency to a lower driving frequency to the driving frequency control unit ex512. Then, the driving frequency control unit ex512 sets the driving frequency to the lower driving frequency than that in the case where the video data is generated by the moving picture coding method and the moving picture coding apparatus described in each of embodiment.

Furthermore, along with the switching of the driving frequencies, the power conservation effect can be improved by changing the voltage to be applied to the LSI ex500 or an apparatus including the LSI ex500. For example, when the driving frequency is set lower, the voltage to be applied to the LSI ex500 or the apparatus including the LSI ex500 is probably set to a voltage lower than that in the case where the driving frequency is set higher.

Furthermore, when the processing amount for decoding is larger, the driving frequency may be set higher, and when the processing amount for decoding is smaller, the driving frequency may be set lower as the method for setting the driving frequency. Thus, the setting method is not limited to the ones described above. For example, when the processing amount for decoding video data in conformity with MPEG-4 AVC is larger than the processing amount for decoding video data generated by the moving picture coding method and the moving picture coding apparatus described in each of embodiments, the driving frequency is probably set in reverse order to the setting described above.

Furthermore, the method for setting the driving frequency is not limited to the method for setting the driving frequency lower. For example, when the identification information indicates that the video data is generated by the moving picture coding method and the moving picture coding apparatus described in each of embodiments, the voltage to be applied to the LSI ex500 or the apparatus including the LSI ex500 is probably set higher. When the identification information indicates that the video data conforms to the conventional standard, such as MPEG-2, MPEG-4 AVC, and VC-1, the voltage to be applied to the LSI ex500 or the apparatus including the LSI ex500 is probably set lower. As another example, when the identification information indicates that the video data is generated by the moving picture coding method and the moving picture coding apparatus described in each of embodiments, the driving of the CPU ex502 does not probably have to be suspended. When the identification information indicates that the video data conforms to the conventional standard, such as MPEG-2, MPEG-4 AVC, and VC-1, the driving of the CPU ex502 is probably suspended at a given time because the CPU ex502 has extra processing capacity. Even when the identification information indicates that the video data is generated by the moving picture coding method and the moving picture coding apparatus described in each of embodiments, in the case where the CPU ex502 has extra processing capacity, the driving of the CPU ex502 is probably suspended at a given time. In such a case, the suspending time is probably set shorter than that in the case where when the identification information indicates that the video data conforms to the conventional standard, such as MPEG-2, MPEG-4 AVC, and VC-1.

Accordingly, the power conservation effect can be improved by switching between the driving frequencies in accordance with the standard to which the video data conforms. Furthermore, when the LSI ex500 or the apparatus including the LSI ex500 is driven using a battery, the battery life can be extended with the power conservation effect.

In the following an embodiment described as Embodiment E is described. There are cases where a plurality of video data that conforms to different standards, is provided to the devices and systems, such as a television and a cellular phone. In order to enable decoding the plurality of video data that conforms to the different standards, the signal processing unit ex507 of the LSI ex500 needs to conform to the different standards. However, the problems of increase in the scale of the circuit of the LSI ex500 and increase in the cost arise with the individual use of the signal processing units ex507 that conform to the respective standards.

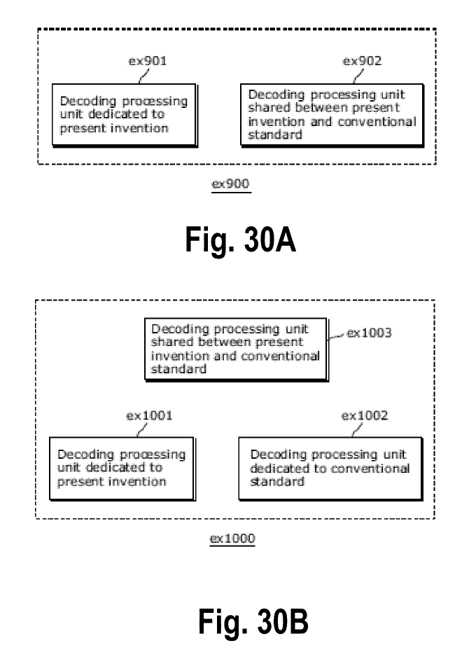

In order to solve the problem, what is conceived is a configuration in which the decoding processing unit for implementing the moving picture decoding method described in each of embodiments and the decoding processing unit that conforms to the conventional standard, such as MPEG-2, MPEG-4 AVC, and VC-1 are partly shared. Ex900 in FIG. 30A shows an example of the configuration. For example, the moving picture decoding method described in each of embodiments and the moving picture decoding method that conforms to MPEG-4 AVC have, partly in common, the details of processing, such as entropy coding, inverse quantization, deblocking filtering, and motion compensated prediction. The details of processing to be shared probably include use of a decoding processing unit ex902 that conforms to MPEG-4 AVC. In contrast, a dedicated decoding processing unit ex901 is probably used for other processing unique to an aspect of the present invention. Since the aspect of the present invention is characterized by inverse quantization in particular, for example, the dedicated decoding processing unit ex901 is used for inverse quantization. Otherwise, the decoding processing unit is probably shared for one of the entropy decoding, deblocking filtering, and motion compensation, or all of the processing. The decoding processing unit for implementing the moving picture decoding method described in each of embodiments may be shared for the processing to be shared, and a dedicated decoding processing unit may be used for processing unique to that of MPEG-4 AVC.

Furthermore, ex1000 in FIG. 30B shows another example in that processing is partly shared. This example uses a configuration including a dedicated decoding processing unit ex1001 that supports the processing unique to an aspect of the present invention, a dedicated decoding processing unit ex1002 that supports the processing unique to another conventional standard, and a decoding processing unit ex1003 that supports processing to be shared between the moving picture decoding method according to the aspect of the present invention and the conventional moving picture decoding method. Here, the dedicated decoding processing units ex1001 and ex1002 are not necessarily specialized for the processing according to the aspect of the present invention and the processing of the conventional standard, respectively, and may be the ones capable of implementing general processing. Furthermore, the configuration of the present embodiment can be implemented by the LSI ex500.

As such, reducing the scale of the circuit of an LSI and reducing the cost are possible by sharing the decoding processing unit for the processing to be shared between the moving picture decoding method according to the aspect of the present invention and the moving picture decoding method in conformity with the conventional standard.

Most of the examples have been outlined in relation to an H.264/AVC based video coding system, and the terminology mainly relates to the H.264/AVC terminology. However, this terminology and the description of the various embodiments with respect to H.264/AVC based coding is not intended to limit the principles and ideas of the invention to such systems. Also the detailed explanations of the encoding and decoding in compliance with the H.264/AVC standard are intended to better understand the exemplary embodiments described herein and should not be understood as limiting the invention to the described specific implementations of processes and functions in the video coding. Nevertheless, the improvements proposed herein may be readily applied in the video coding described. Furthermore the concept of the invention may be also readily used in the enhancements of H.264/AVC coding and/or HEVC currently discussed by the JCT-VC.

Summarizing, the present invention relates to deblocking filtering, which may be advantageously applied for block-wise encoding and decoding of image or video signal. In particular, the present invention relates to automated decision on whether to apply or skip deblocking filtering for a block and to selection of the deblocking filter. The decision and/or selection is performed for predefined individual pixels based on the amount of quantization of the block the boundary of which is to be deblocked and on the amount of quantization of its neighboring block adjacent to the boundary, as well as on the position of the individual pixels.

1. A method for deblocking filtering of image blocks of pixels comprising:
judging whether or not to apply a deblocking filter to pixels of a first block and a second block adjacent to a boundary between the first block and the second block, and
applying a deblocking filter when the judging is positive and not applying a deblocking filter when the judging is negative,
wherein the judging and/or a selection of the deblocking filter for an individual pixel of the block is based on a quantization parameter applied to the first block and a position of the individual pixel.

2. The method according to claim 1, further comprising:
determining for the individual pixel a first threshold based on the quantization parameter applied to the first block, a quantization parameter applied to the second block, and the position of the individual pixel,
wherein the judging includes comparing a measure based on features of the first block and/or the second block with the first threshold.

3. The method according to claim 1, further comprising:
determining for the individual pixel a second threshold based on the quantization parameter applied to the first block, a quantization parameter applied to the second block, and the position of the individual pixel, and
selecting the deblocking filter from a plurality of deblocking filters based on comparing a measure based on features of the first block and/or the second block with the second threshold.

4. The method according to claim 1, wherein the judging is performed for each individual pixel out of a predefined plurality of pixels in the first block and in the second block, the plurality of pixels being adjacent to the boundary between the first block and the second block.

5. The method according to claim 1, wherein the position indicates a distance of the individual pixel from the boundary between the first block and the second block.

6. The method according to claim 1, wherein the position indicates whether the individual pixel belongs to the first block or to the second block.

7-9. (canceled)

10. A method for encoding a current block of an image including a plurality of pixels, the method comprising:
compressing and reconstructing the current block, and
applying filtering according to claim 1 to the reconstructed block.

11. A method for decoding a coded current block of an image including a plurality of pixels, the method comprising:
reconstructing the coded current block, and
applying filtering according to claim 1 to the reconstructed block.

12. (canceled)

13. An apparatus for deblocking filtering of image blocks of pixels comprising:
a judging unit for judging whether or not to apply a deblocking filter to pixels of a first block and a second block adjacent to a boundary between the first block and the second block, and
a filtering unit for applying the deblocking filter when the judging is positive and not applying the deblocking filter when the judging is negative,
wherein the judging unit is configured to judge and/or to select the deblocking filter for an individual pixel of the block based on a quantization parameter applied to the first block and a position of the individual pixel.

14-24. (canceled)

25. The method according to claim 1,
wherein the judging is performed based on the quantization parameter applied to the first block and not on a quantization parameter applied to the second block.
